(19) United States
(12) Patent Application Publication
(10) Pub. No.: US 2025/0050355 A1
(43) Pub. Date: Feb. 13, 2025

(54) METHOD FOR CONTROLLING A CENTRIFUGE AND CENTRIFUGE

(71) Applicant: Beckman Coulter, Inc., Brea, CA (US)

(72) Inventors: Paul H. Kraght, Brea, CA (US); Stephen J. Donato, Brea, CA (US); Richard L. Situ, Brea, CA (US)

(21) Appl. No.: 18/723,610

(22) PCT Filed: Dec. 27, 2022
(86) PCT No.: PCT/IB2022/062804

§ 371 Date: Jun. 24, 2024

Related U.S. Application Data
(60) Provisional application No. 63/294,990, filed on Dec. 30, 2021.

(51) Int. Cl. B04B 13/00; B04B 15/00

(52) U.S. Cl. CPC B04B 13/00; B04B 15/00

(57) ABSTRACT

In a method for controlling a centrifuge (100) comprising a rotor (106) and a drive component (104) for the rotor (106), an acoustic signal (AS) is received, at a computing device (102), via a sound transducer (108) located proximate to the rotor (106) of the centrifuge (100). The acoustic signal (AS) is pre-processed, by the computing device (102), by emphasizing at least one predetermined signal feature of the acoustic signal (AS), the signal feature indicating an abnormal operation of the centrifuge (100). An abnormal operation of the centrifuge (100) is detected, by the computing device (102), by processing the emphasized signal feature. An alarm signal and/or a termination signal (212) is generated, by the computing device (102), if an abnormal operation of the centrifuge (100) is detected.

The present invention relates generally to centrifuge operations. More specifically, the present invention relates to methods of controlling a centrifuge and to a centrifuge, in particular to detecting abnormal operation conditions, such as tube breakage, and methods for controlling centrifuges in response to the detection of an abnormal operation.

### BACKGROUND

A centrifuge is an instrument used to separate components in a mixture. During centrifuge procedures the mixture, which is located inside a tube, may be spun at very high speeds. As the mixture spins, centrifugal forces acting on the various components of the mixture cause the components to stratify. After stratification has occurred, the various components may be removed from the tube using pipets, decanting, or other procedures.

During the operation of a centrifuge, it is possible for an abnormal operation to occur, such as excessive forces due to rotor imbalance, or a failing bearing, or tube breakage. Depending on the severity, such abnormal operation should be communicated to the user, and/or the centrifuge should be halted to avoid damage. Due to an automated nature of some centrifuges, a user may not be expected to detect such abnormalities.

A problem relates to enabling an improved operation of a centrifuge, in particular to an improved and/or automated detection of an abnormal operation of the centrifuge.

This problem is solved by the subject-matter of the independent claims. Preferred embodiments are the subject-matter of the dependent claims.

### Method for Controlling a Centrifuge

According to an aspect, there is a method for controlling a centrifuge comprising a rotor and a drive component for the rotor. The method comprises receiving, at a computing device, an acoustic signal via a sound transducer located proximate to the rotor of the centrifuge. The method further comprises pre-processing, by the computing device, the acoustic signal by emphasizing at least one predetermined signal feature of the acoustic signal, the signal feature indicating an abnormal operation of the centrifuge. The method comprises detecting, by the computing device, an abnormal operation of the centrifuge by processing the emphasized signal feature. The method further comprises generating, by the computing device, an alarm signal and/or a termination signal if an abnormal operation of the centrifuge is detected.

The centrifuge may be configured to receive at least one tube comprising a mixture and to separate components of the mixture by spinning the at least one tube so that centrifugal forces acting on the various components of the mixture cause the components to stratify.

The rotor and the drive component of the rotor may be configured to enable a spinning movement of a tube receiving section of the centrifuge. As such, the rotor and the drive component may provide a basic function of the centrifuge. The drive component may comprise a motor for driving a rotating motion of the rotor. The rotor may be coupled to the tube receiving section and/or it may comprise the tube receiving section itself. The tube receiving section is configured to receive at least one tube.

The computing device may comprise a processor and/or a software module. The computing device may be provided as a PC and/or mobile computer. The software module may be programmed to execute various steps of the method, e.g., the pre-processing, the detecting, the processing, and/or the generating step. The computing device may be provided as a part of the centrifuge, or it may be provided as an external element in communication with the centrifuge. The computing device may, e.g., be in communication with a plurality of centrifuges, and it may be configured to detect abnormal operations of any of the plurality of centrifuges.

The sound transducer may comprise a microphone and/or as a sound sensor. The sound transducer is capable of detecting a sound emitted by and/or at the centrifuge. Based on the sound detected by the sound transducer, the acoustic signal is generated.

The acoustic signal may be provided as a digital and/or analogue signal. The acoustic signal may be time dependent. The acoustic signal may be a continuous signal and/or a sampled signal. In case the acoustic signal is sampled, the sampling rate may be shorter than the time required for a single revolution of the rotor of the centrifuge. This may enable to even detect changes of the sound within a single revolution of the rotor.

The sound transducer may be capable of detecting sound at least over a portion of the audible sound spectrum. Additionally, the sound transducer may be capable of receiving sound in the ultrasonic range.

The sound transducer is arranged proximate to the rotor of the centrifuge. For example, the sound transducer may be arranged at most about 50 cm spaced from the rotor, preferably at most about 20 cm or at most about 10 cm spaced from the rotor. This enables the sound transducer to generate the acoustic signal depending on the sound generated during the operation of the centrifuge. The sound transducer may be provided as part of the centrifuge. The sound transducer may comprise a plurality of elements, e.g., a plurality of sound transducers arranged at different positions proximate to the rotor.

The computing device is configured to emphasize at least one predetermined signal feature of the acoustic signal during a pre-processing step. The signal feature may be recognized as an indication of an abnormal operation of the centrifuge. The signal feature may, e.g., relate to a frequency, a frequency change, an amplitude, and/or an amplitude change of the acoustic signal. In particular, the signal feature may relate to an increased sound level, a momentary spike, and/or a periodic fluctuation of the acoustic signal. During the pre-processing, one or more filters may be applied to the acoustic signal, e.g., to emphasize relevant parts of the acoustic signal. Furthermore, components and/or features of the acoustic signal may be emphasized and/or suppressed.

The signal feature may be emphasized using at least one metric based on the acoustic signal. The acoustic signal may comprise different features which may be correlated to different abnormal operation scenarios of the centrifuge. To emphasize different signal features, different metrics may be applied to pre-process and/or process the acoustic signal.

The computing device is further configured to detect an abnormal operation of the centrifuge by processing the emphasized signal feature. The emphasized signal feature may be processed by an evaluation of the at least one metric. For example, depending on the on a value that is determined by the metric from the detected acoustic signal, at least one abnormal operation scenario of the centrifuge may be detected.

In case an abnormal operation of the centrifuge is detected, the computing device generates either an alarm signal or a termination signal or both. The termination signal may be transmitted to the drive component of the centrifuge which may then stop the rotor. The termination signal may be generated if the abnormality is detected with a high probability, e.g., at a predetermined certainty, and/or if a rather relevant abnormality type is detected, e.g., a tube breakage event.

In case the abnormality is detected with a low probability, and/or if a less relevant abnormality is detected, the alarm signal may be generated. The alarm signal may be transmitted to a display and/or signal light and/or to a speaker warning an operator to check on the centrifuge.

The pre-processing of the acoustic signal by emphasizing a relevant signal feature and the processing of the acoustic signal may enable an automatic detection of an abnormal operation of the centrifuge. This may enable a better controlling of the centrifuge, in particular a timely termination of the operation of the centrifuge in response to the detection of an abnormality.

According to an embodiment, the predetermined signal feature indicates a tube breakage event in the centrifuge and/or other abnormal operation of the centrifuge. The computing device detects as the abnormal operation the tube breakage event in the centrifuge and/or the other abnormal operation of the centrifuge. The abnormal operation may be a malfunction of the centrifuge, in particular of the drive component and/or the rotor. However, it may also relate to a malfunction of another component of the centrifuge, e.g., a rotor bearing and/or a drive train. The abnormal operation may relate to an imbalanced rotation of the rotor and/or a failing rotor bearing and/or another malfunction impairing a steady rotation of the rotor. Depending on the nature of the detected abnormality, the termination signal and/the alarm signal is generated. For example, in case a tube breakage event is detected, the computing device may be configured to always terminate the operation of the centrifuge automatically, because this corresponds to a critical abnormality. In case another abnormality is detected, e.g., relating to an imbalanced rotation, the alarm signal may be generated, so an operator may check on the centrifuge.

According to an embodiment, the signal feature of the acoustic signal corresponds to a momentary spike and/or an increased sound level and/or a periodic fluctuation in the acoustic signal received by the sound transducer. The momentary spike may be caused by a tube breakage event and/or another noise in a laboratory, e.g., a door closing. During the pre-processing step, the acoustic signal is evaluated to check whether an abnormality occurred at the centrifuge, e.g., a tube breakage event, or whether it was only an external disturbance. Similarly, also the elevated noise level or the periodic fluctuation does not necessarily have to originate from the operation of the centrifuge. The pre-processing and/or processing step may enable a reliable evaluation whether an abnormal operation of the centrifuge occurred, or whether only an external disturbance occurred.

According to a further development of this embodiment, during the detection of the abnormal operation, the computing device:
correlates the momentary spike of the acoustic signal to a tube breakage event; and/or
correlates the increased sound level of the acoustic signal to an abnormal operation of the centrifuge, in particular of the rotor and/or drive component; and/or
correlates the periodic fluctuation of the acoustic signal to an abnormal operation of the centrifuge, in particular of the rotor and/or the drive component.

A tube breakage event usually causes a sharp spike of the acoustic signal, a spike that is even shorter than, e.g., a closing door and/or an item falling on the floor. Thus, a very sharp momentary spike may be correlated to a tube breakage event. The momentary spike is a signal feature that may be emphasized during the pre-processing of the acoustic signal to detect a tube breakage event.

An increased sound level may be caused by a plurality of different reasons. Usually, the sound level a centrifuge generates is within a specific range of operation. The sound range may depend on the type of the centrifuge and/or on the load. In case the centrifuge continuously exceeds the sound level, an abnormal operation may be detected, e.g., caused by wear of a component of the centrifuge and/or an imbalanced rotor and/or by another disruptive factor. The increased sound level is a signal feature that may be emphasized during the pre-processing of the acoustic signal to detect such abnormalities.

A periodic fluctuation may be caused by an imbalanced rotor and/or a malfunction of a drive train (which may or may not include the motor) and/or a malfunction of motor and/or a bearing malfunction of the rotor and/or a structural malfunction of the rotor, e.g., the rotor may include a crack, e.g., in an ultra-centrifuge. The periodic fluctuation may be correlated, e.g., to the rotational speed to check whether the periodic fluctuation may be caused by the centrifugal rotation. The periodic fluctuation is a signal feature that may be emphasized during the pre-processing of the acoustic signal to detect such abnormalities.

According to an embodiment, the computing device evaluates the acoustic signal and/or the at least one predetermined signal feature by means of at least one metric for detecting the abnormal operation of the centrifuge. The computing device correlates the at least one metric to at least one metric-specific threshold for detecting the abnormal operation of the centrifuge. Different metrics may emphasize different signal features of the acoustic signal. The metric-specific threshold may depend on the specific metric. For example, a harmonic metric may be used to detect a periodic fluctuation. Then the harmonic metric may be correlated to a harmonic threshold. Similarly, a pop metric may be correlated to a breakage threshold, a quantitation metric may be correlated to a quantitation threshold, etc. For each applied metric, a metric-specific threshold may be used to detect whether the centrifuge operates as scheduled, or whether there is an abnormal operation.

### Pre-Processing of the Acoustic Signal

The method may emphasize different signal features for detecting different kinds of abnormal operations of the centrifuge. In some embodiments for detecting a momentary spike and/or an increased sound level of the acoustic signal, the acoustic signal is pre-processed as described below. It is noted that when a periodic fluctuation of the acoustic signal should be detected, a different approach for pre-processing the acoustic signal may be applied which is described further below.

According to an embodiment, the computing device calculates an acoustic signal magnitude from the acoustic signal. The acoustic signal magnitude may be calculated during the pre-processing of the acoustic signal. The acoustic signal magnitude may be related to the amplitude of the acoustic signal. For example, the acoustic signal magnitude may be the absolute value and/or a squaring value of the amplitude of the acoustic signal. The acoustic signal magnitude may also be scaled to a predetermined level. The acoustic signal magnitude may be provided as a time dependent value and/or function.

According to a development of the embodiment, the computing device calculates a signal magnitude profile from the acoustic signal magnitude by decimating and/or smoothing the acoustic signal magnitude. Herein, a different decimation may be applied resulting in differently reduced signal magnitude profiles. The applied decimation method may depend on the further evaluation, e.g., whether a momentary spike should be detected and/or whether an increased noise level should be detected. The decimation may include grouping a predetermined number of samples of the acoustic signal magnitude (e.g., at consecutive times), and then calculating an average and/or a median and/or similar of the group of samples, e.g., a median-of-medians. Therefore, the signal magnitude profile may, e.g., be calculated as moving average and/or moving median of a group of samples of the acoustic signal which moves with the time. The decimation may reduce the computational load and, thus, enable the computing device to better handle and/or evaluate the acoustic signal in real time to detect the abnormality in a timely manner.

### Calculation of a Quantitation Metric

According to a development of the embodiment, a quantitation metric is calculated by calculating at least one representative magnitude value from at least one range of the signal magnitude profile. Furthermore, the quantitation metric is correlated to an abnormal operation of the rotor and/or other drive component by using a quantitation threshold. Therein, the representative magnitude value may, e.g., be an average, a median, or a median-of-medians of the signal magnitude profile over the chosen range. The range and/or the quantitation threshold may be established empirically, e.g., for emphasizing an abnormally increased sound level of the centrifuge operation. The range and/or the quantitation threshold may depend on the type of centrifuge and/or the number of tubes operated at the same time. The quantitation metric may be used to emphasize and/or detect an increased sound level of the acoustic signal possibly hinting on an abnormal operation of the centrifuge. The quantitation metric emphasizes an increased sound level of the acoustic signal. The quantitation metric may be intended to respond to a persistently elevated signal magnitude profile, whereas evaluating the signal magnitude profile itself could respond to a momentary increase. While the quantitation metric may be based directly on the signal magnitude, it is preferably based on the signal magnitude profile. This may reduce the amount of computation, since the signal magnitude profile is typically at a reduced sampling rate compared with the signal magnitude.

According to a development of the embodiment, the representative magnitude value is calculated as a moving median or as a median-of-medians of the signal magnitude profile over a predetermined time range. Experiments show that the median is, at least for some centrifuges, better suited than a mean to detect increased sound levels, because the mean does not respond as strongly to only temporarily increased sound levels caused by external disturbances as the mean. The median-of-medians is an embodiment of a median which may enable decreasing the number of required calculations to a point that improves real time detection of the abnormality and/or enables a timely detection of the abnormality.

According to a development of the embodiment, the predetermined time range of the signal magnitude profile is from about 0.05 s to about 3 s, in particular from about 0.2 s to about 1 s. For example, a time range of about 0.5 s may be optimal for some centrifuges. This time range may enable a reliable detection within the computational abilities of standard processors.

### Calculation of a Pop Metric

According to a development of the embodiment relating to the pre-processing of the acoustic signal as described above, the computing device calculates a signal rise rate by comparing the acoustic signal magnitude and/or the signal magnitude profile at a plurality of closely-spaced times. The signal rise rate may include some kind of fraction and/or product of the acoustic signal magnitude and/or the signal magnitude profile. The signal rise rate may alternatively or additionally include a derivative of the acoustic signal magnitude and/or the signal magnitude profile. The signal rise rate may be provided as a mathematical expression describing how fast the amplitude of the acoustic signal rises and/or falls. A detected rise and/or fall of the acoustic signal magnitude and/or the signal magnitude profile at such closely-spaced times may be caused by a tube breakage event. The method may be configured to distinguish a tube breakage event from different disturbance, e.g., a closing door. Therefore, the comparison may increase the reliability of detecting a tube breakage event by distinguishing it at least from some external disturbances. Because a tube breakage event usually results in sharper sounds than another disturbance, these occurrences may be distinguished from each other. For example, the method may look for a particular sharp momentary spike. The pop metric may be used to emphasize and/or detect such a particular sharp momentary spike of the acoustic signal possibly hinting on an abnormal operation of the centrifuge like a tube breakage event.

According to a development of the embodiment, the plurality of closely-spaced times includes two times less than 50 ms apart. Investigating such closely-spaced times may enable detecting very sharp spikes in the acoustic signal that may be caused by a tube breakage event.

According to a development of the embodiment, a pop metric is calculated using the acoustic signal magnitude and/or the signal magnitude profile and further using the signal rise rate. A momentary spike in the pop metric is correlated to a tube breakage event in the centrifuge. Therein, the pop metric may be calculated from a differently decimated signal magnitude profile than the quantitation metric described above. The pop metric may include fractional arithmetic relating to the rise rate over the acoustic signal magnitude and/or the signal magnitude profile and/or a similar multiplication. During the correlation, the pop metric may be compared to a breakage threshold. In case the pop metric exceeds the breakage threshold, a tube breakage event may be detected, which may result in a termination signal as described above. The breakage threshold may be established empirically, e.g., by recording and evaluating at least one tube breakage event and calculating the according pop metric for the event.

Calculation of a Fundamental and/or Harmonic Metric

According to an embodiment, the acoustic signal is sampled at a plurality of different predetermined angular positions of the rotor, thereby providing a plurality of angular samples of the acoustic signal, namely at least one angular sample at each of the different predetermined angular positions. The angular samples may be synchronized, e.g., at every 0° position of the rotor. After about half the time the rotor requires for a full rotation, an angular sample of the acoustic signal may be recorded at the 180° position of the rotor. At a quarter of the time the rotor requires for a full rotation, an angular sample of the acoustic signal may be recorded at the 90° position of the rotor. Similarly, by correlating the time at which an angular sample of the acoustic signal is recorded to the corresponding angular position of the rotor by considering the time the rotor requires for a full rotation (e.g., the rotation frequency), the angular sample of the acoustic signal may be correlated to the corresponding angular position of the rotor. The angular sample represents the acoustic sound the centrifuge emits at the angular position. The angular samples of the acoustic signal may include regular angular samples at any predetermined angular position, and they may include correlated angular samples which are correlated to the regular angular samples. Therein, a correlated angular sample may be sampled at a predetermined angular distance to the regular angular sample it is correlated to. According to an embodiment, the plurality of angular samples of the acoustic signal comprises at least one regular angular sample (at any predetermined angular position) and at least one correlated angular sample which is arranged at a predetermined angular distance from the at least one regular angular sample. Therein, the predetermined distance may, e.g., be 90° or 45°. For each such regular angular sample of the acoustic signal, there may be recorded at least one correlated angular sample of the acoustic signal.

The above angular sampling may enable a frequency analysis of the acoustic signal. The angular sampling of the acoustic signal may be evaluated to detect periodic fluctuations of the signal that may fluctuate with the rotation of the rotor of the centrifuge and/or its harmonics.

According to a development of this embodiment, the angular samples of the acoustic signal at the different predetermined angular positions of the rotor are correlated to each other. The correlation may allow a Fourier analysis and/or a frequency analysis inspired by and/or similar to a Fourier analysis at reduced computational resources. Such a frequency analysis inspired by a Fourier analysis may, e.g., be a cosine analysis and/or a sine analysis (e.g., as described in more detail below) during which the angular samples of the acoustic samples are used to calculate energy equivalents for the fundamental and/or a harmonic of the acoustic signal. Depending on the strength of the at least one energy equivalent, a periodic fluctuation of the acoustic signal may be detected.

According to a development of this embodiment, consecutive and/or overlapping time ranges are established, each time range spanning over a plurality of rotations of the rotor. At each of the different predetermined angular positions, a representative angular value of the angular samples of the acoustic signal at the different angular positions for each of the established time ranges is determined, thereby providing a plurality of representative angular values of the angular samples. The representative angular values may depend on the amplitude of the acoustic signal at the correlated angular position. Each time range may include a plurality of rotations, so each time range encompasses a plurality of angular samples of the acoustic signal at each angular position.

According to a development of this embodiment, the representative angular values are calculated as median or as median-of-medians of the angular samples of the acoustic signal of the respective time range at the corresponding angular positions. Experiments show that both the median and the median-of-medians improve the detection over an arithmetic mean. Therein, the median-of-medians reduces the computational requirements to a point that may enable real-time detection.

According to a development of this embodiment, a fundamental component of the acoustic signal is calculated using at least one angular sample of the acoustic signal and/or at least one representative angular value at at least a first predetermined angular position of the rotor and, additionally, at least one angular correlated sample of the acoustic signal and/or at least one correlated representative angular value at the first predetermined angular position plus 90°. Alternatively or additionally, a harmonic magnitude of the acoustic signal is calculated using at least one angular sample of the acoustic signal and/or at least one representative angular value at a second predetermined angular position of the rotor and, additionally, at least one correlated angular sample of the acoustic signal and/or at least one correlated representative angular value at the second predetermined angular position plus 45°. While both the fundamental component and the harmonic component may be calculated by using only a single regular angular sample and its correlated angular sample, better results are achieved by using at least two regular angular samples and their two correlated angular samples, respectively. Even better results may be achieved by using four regular angular samples and their four correlated angular samples, respectively, for both the fundamental component and the harmonic component. The fundamental component may be considered as an indicator of a periodic fluctuation in the acoustic signal going with the angular speed of the rotor. The harmonic magnitude may be considered as an indicator of a periodic fluctuation in the acoustic signal going with a harmonic of the angular speed of the rotor, in particular with the 2^{nd} harmonic.

According to a development of this embodiment, the fundamental component is calculated using angular samples at the angular position of the rotor of 0°, 45°, 180°, and 225° and, additionally, correlated angular samples at the angular position of the rotor of 90°, 135°, 270°, and 315°. Additionally or alternatively, the harmonic magnitude is calculated using angular samples at the angular position of the rotor of 0°, 90°, 180°, and 270° and, additionally, correlated angular samples at the angular position of the rotor (106) of 45°, 135°, 225°, and 315°. These specific angular positions are mathematically rather efficient (as will be explained in more detail below) and may result, thus, in a rather reliable calculation that may be executed in real time. The angular samples may be used directly to calculate the fundamental component and/or the harmonic magnitude. Alternatively, the angular samples may be used to calculate at least one intermediate value, e.g., a representative angular value at the respective angular position. Then, the fundamental component and/or the harmonic magnitude may be calculated from this at least one intermediate value.

According to a development of this embodiment, a fundamental metric is calculated using the fundamental component and/or a harmonic metric is calculated using the harmonic magnitude. The fundamental metric and/or the harmonic metric is correlated to an imbalanced rotation of the rotor by using a fundamental threshold for the fundamental metric and/or a harmonic threshold for the harmonic metric. The fundamental metric may be used to detect a periodic fluctuation of the acoustic signal going with the fundamental, i.e., the first harmonic, of the rotation of the centrifuge, and the harmonic metric may be used to detect a periodic fluctuation of the acoustic signal going with a harmonic of the rotation of the centrifuge, in particular the second harmonic. The respective threshold(s) may be established empirically.

### Combination of the Different Detection Methods

According to an embodiment, during the detection of the abnormal operation, the computing device:
correlates a momentary spike of the acoustic signal to a tube breakage event by the method described above in the section “CALCULATION OF A POP METRIC”; and/or
correlates an increased sound level of the acoustic signal to an abnormal operation of the centrifuge, in particular of the rotor and/or drive component, by the method described above in the section “CALCULATION OF A QUANTITATION METRIC”; and/or
correlates a periodic fluctuation of the acoustic signal to an abnormal operation of the centrifuge, in particular of the rotor and/or the drive component, by the method described above in the section “CALCULATION OF A FUNDAMENTAL AND/OR HARMONIC METRIC”.

In other words, the different pre-processing and/or processing methods of the acoustic signal described above may be executed in parallel and/or serially to emphasize and detect different signal features indicative of different abnormalities. Therefore, it is noted that the dependencies of the claims are not understood to be limiting the embodiments to only those claims they explicitly depend on, but the claim groups directed to the specific evaluation method may also be executed in parallel and/or serially to the other claim groups relating to another evaluation method.

### Centrifuge

An aspect relates to a centrifuge comprising a drive component, a rotor coupled to the drive component, a sound transducer located proximate the rotor, and a computing device electrically coupled to the sound transducer and the drive component. Therein, the computing device is configured to execute the method according to the above aspect for controlling the centrifuge.

The centrifuge may be used to execute the method according to the previous aspect. Therefore, the disclosure of the method also relates to the centrifuge and vice versa.

During the operation of centrifuges, it is possible for a sample tube to break due to the stresses of the high centrifugal force. If a tube breaks, it may contaminate the entire rotor of the centrifuge, and requires manual intervention to clean up. Some centrifuges may be intended to be loaded and unloaded automatically, so manual inspection for broken tubes may be difficult, time consuming and/or contamination prone. As disclosed herein, centrifuges may be equipped to detect tube breakage during autonomous operations.

Also, during the operation of centrifuges, operational malfunctions may occur due to the normal wear and tear and/or stresses placed on components, such as bearings, or unbalanced centrifuge rotors. The operational malfunctions may result in damage to tubes and/or contamination the entire rotor of the centrifuge, as well as damage to the centrifuge. As disclosed herein, centrifuges may be equipped to detect tube breakage and other malfunctions during autonomous operations.

As disclosed herein, a centrifuge may include the drive component, the rotor coupled to the drive component, and the acoustic transducer, sometimes also referred to as sound transducer, located proximate the rotor. The computing device may comprise a processor and it may be electrically coupled to the acoustic transducer and the drive component. A memory of the computing device may store instructions that, when executed by the processor, cause the processor to perform actions for detecting an abnormality in the acoustic signal received from the acoustic transducer. The abnormality in the acoustic signal may be correlated to an abnormality in an operation of the centrifuge. As used herein, abnormality may include mechanical failure of the centrifuge itself and/or a tube breakage event during a centrifuge process. For example, an abnormality may be an imbalanced rotor, a worn bearing, a tube breakage event, etc. Upon detecting the abnormality, the termination signal and/or the alarm signal may be generated and, e.g., transmitted to the drive component to terminate rotation of the rotor.

As disclosed herein, the acoustic transducer may include an array of microphones. The abnormality in the acoustic signal may include a fluctuation in the acoustic signal received by the sound transducer. The abnormality in the acoustic signal may include a momentary spike in the acoustic signal received by the sound transducer. The abnormality in the acoustic signal may include a persistent deviation, as distinguished from a momentary spike, in the acoustic signal from a baseline.

Detecting the abnormality in the acoustic signal may include detecting a periodic fluctuation in the acoustic signal received by the sound transducer. Detecting the abnormality in the acoustic signal may include correlating the abnormality in the acoustic signal to an imbalance in the rotor, thus allowing for an inspection and/or maintenance to be performed before a failure occurs. Detecting the abnormality in the acoustic signal may include correlating the abnormality in the acoustic signal to a sound associated with a tube breakage event so that the centrifuge can be shut down to avoid contamination. Detecting the abnormality in the acoustic signal may include detecting a spike in the amplitude in the acoustic signal. The amplitude may be of the acoustic signal or a transformation of the acoustic signal, which may include a noise-shaped acoustic signal, an acoustic signal magnitude, or a signal magnitude profile.

Methods for determining the signal magnitude may include, but are not limited to, squaring values, finding the absolute value of the signal, etc.

As disclosed herein, the acoustic signal, sometimes referred to as an output signal, may be a voltage signal, which may be generated by a microphone or other acoustic transducer, and detecting the abnormality in the acoustic signal may include detecting a momentary spike in the output signal. The acoustic signal may be pre-processed via a pre-amp and an analog-to-digital converter (ADC), thus obtaining a digital acoustic signal Examples of the acoustic signal include the voltage signal, and the digital acoustic signal. Noise from the acoustic signal may be filtered via a noise shaping filter.

The systems and methods disclosed herein may allow for the monitoring and detecting of other abnormal conditions during operation of centrifuges, such a mechanical failure of a component of the centrifuge alternatively or in addition to tube breakage events. For example, the systems and methods disclosed herein may be used to detecting an unbalanced rotor. Minor imbalance may be unavoidable and may have little effect on the noise of the rotor. However, a major imbalance may cause significant changes in the noise. These changes may be detected as different from normal, and the imbalance can be flagged. In addition, detecting a failing bearing may be possible using the systems and methods disclosed herein. For instance, a failing bearing may cause noise which is not normally present. For example, a failing bearing may cause a rattling noise, a screeching noise, etc. that may be detected and flagged as a possible abnormal operating condition warranting further investigation.

The above discussion is intended to provide an overview of subject matter of the present patent application. It is not intended to provide an exclusive or exhaustive explanation of the invention. The description below is included to provide further information about the present patent application.

The numbers and/or angles given in the claims and the description are not limited to the exact numbers and/or angles, but may include measurement inaccuracies within limits that still enable solving the underlying problem.

The invention is further illustrated in reference to embodiments shown in the figures. Embodiments of the invention are described with reference to the figures. Features of the embodiments shown in the figures may be combined with alternative embodiments. Identical reference numbers may identify identical or similar features of the embodiments.

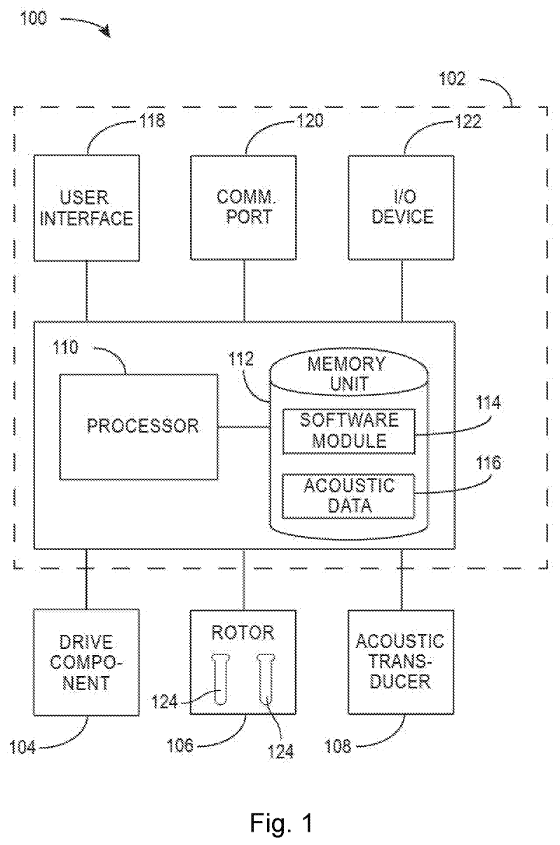

FIG. 1 shows an example schematic of a centrifuge consistent with at least one embodiment of this disclosure.

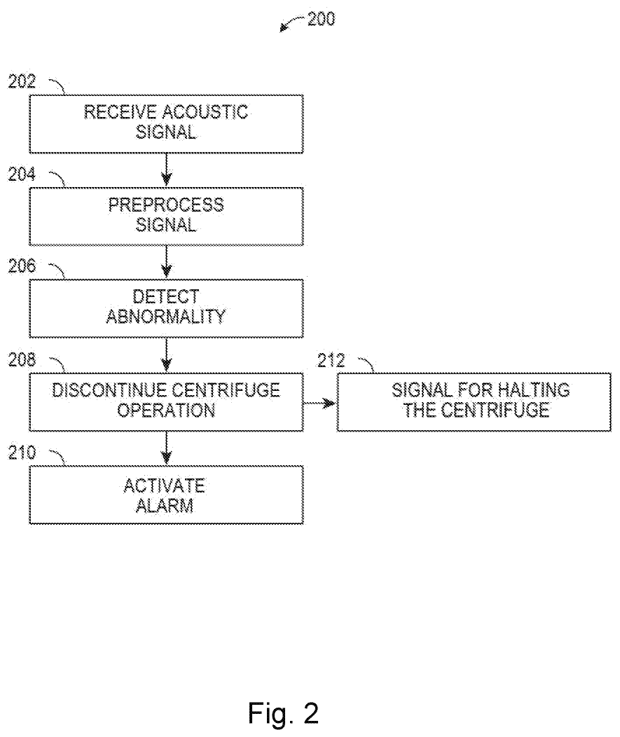

FIG. 2 shows a method consistent with at least one embodiment of this disclosure.

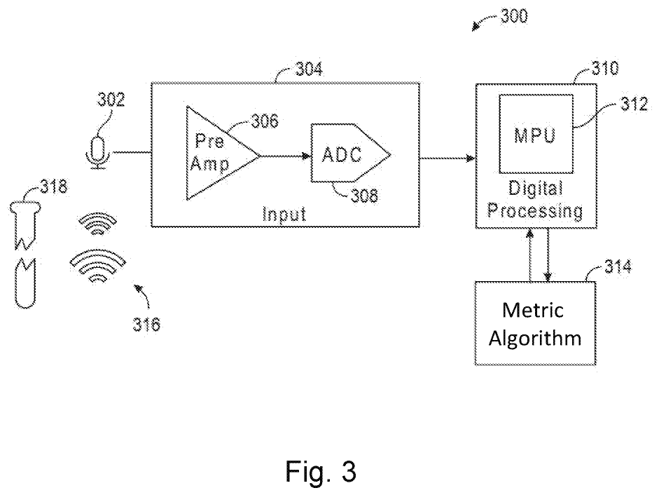

FIG. 3 shows a schematic of a processing system consistent with at least one embodiment of this disclosure.

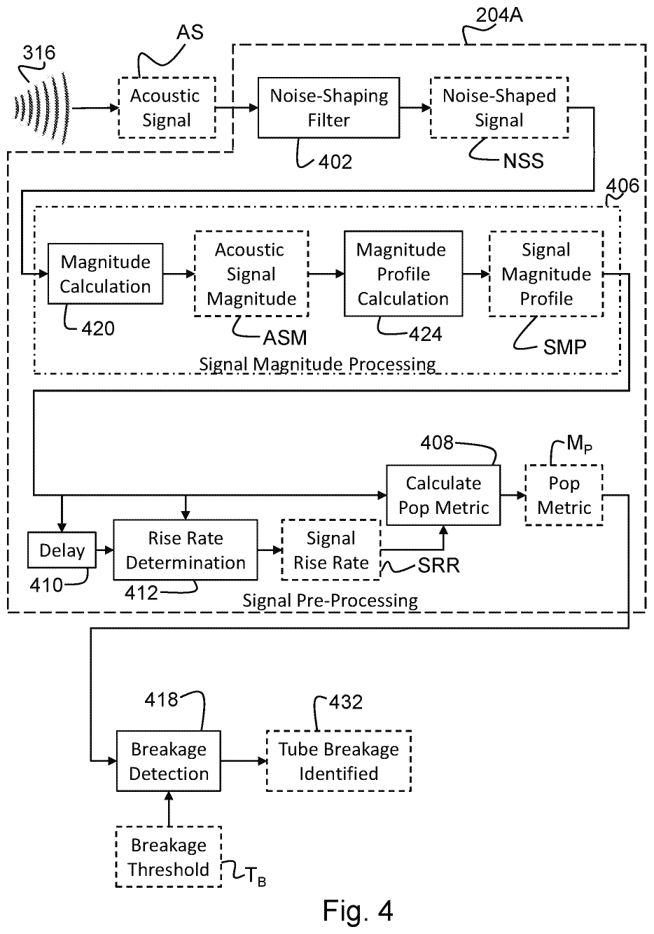

FIG. 4 shows a block diagram of a first algorithm consistent with at least one embodiment of this disclosure.

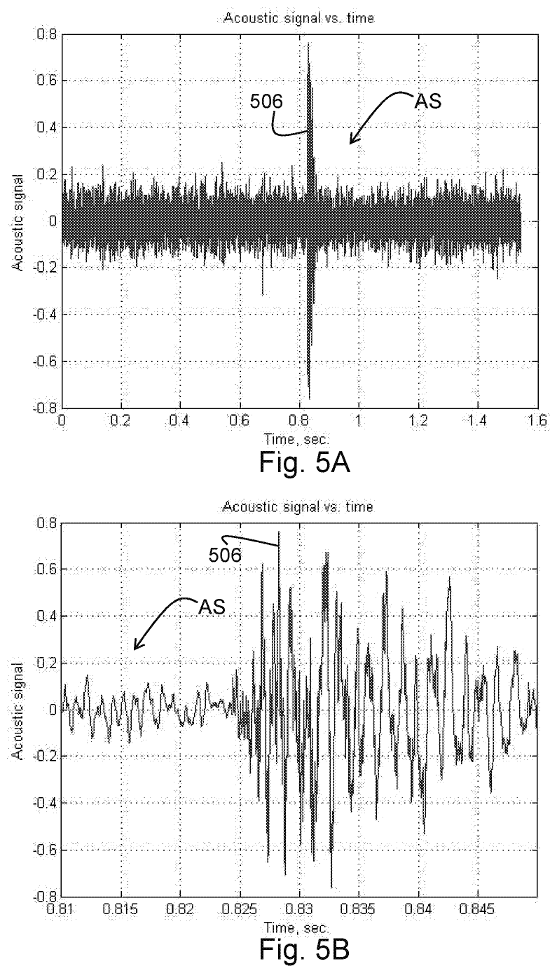

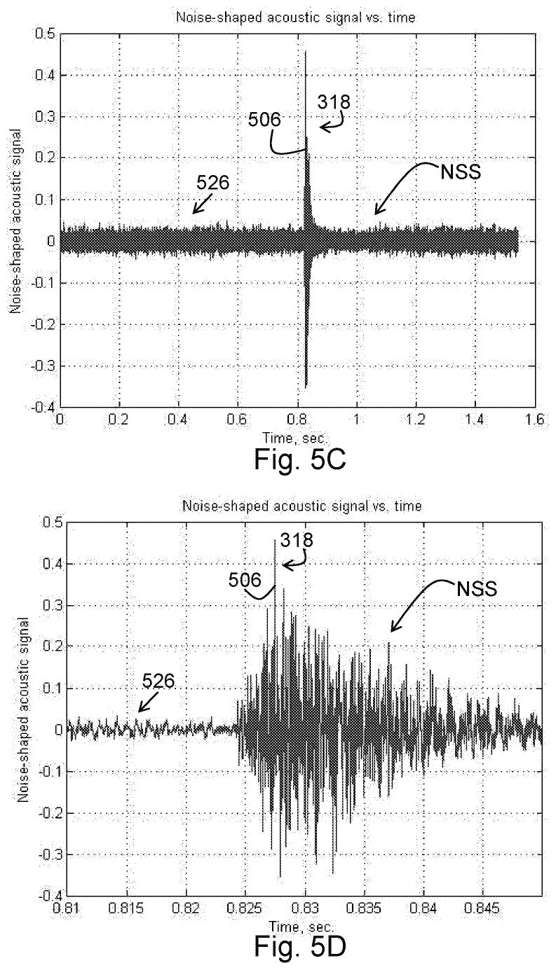

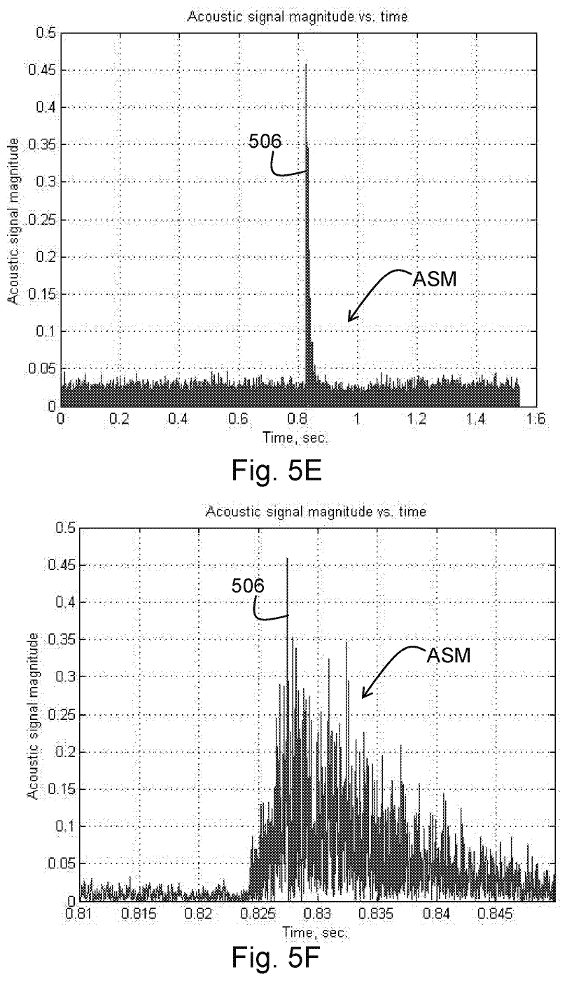

FIGS. 5A and 5B each show a plot of an acoustic signal consistent with at least one embodiment of this disclosure.

FIGS. 5C and 5D each show a plot of a noise-shaped acoustic signal consistent with at least one embodiment of this disclosure.

FIGS. 5E and 5F each show a plot of an acoustic signal magnitude consistent with at least one embodiment of this disclosure.

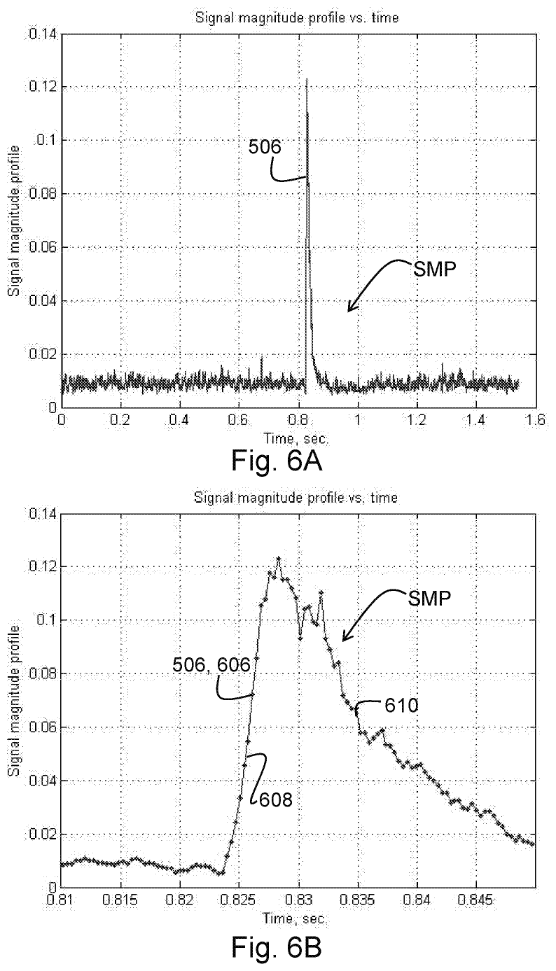

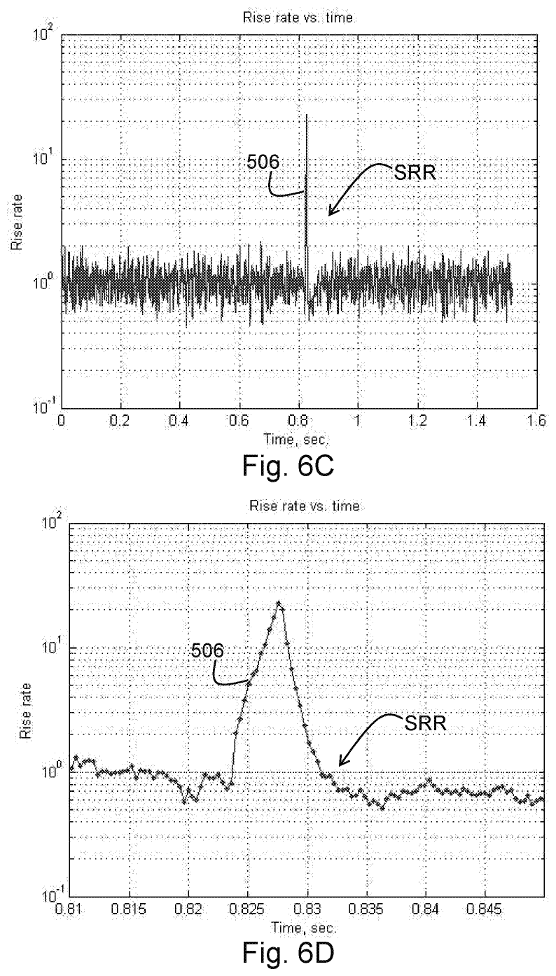

FIGS. 6A and 6B each show a plot of a signal magnitude profile consistent with at least one embodiment of this disclosure.

FIGS. 6C and 6D each show a plot of a rise rate consistent with at least one embodiment of this disclosure.

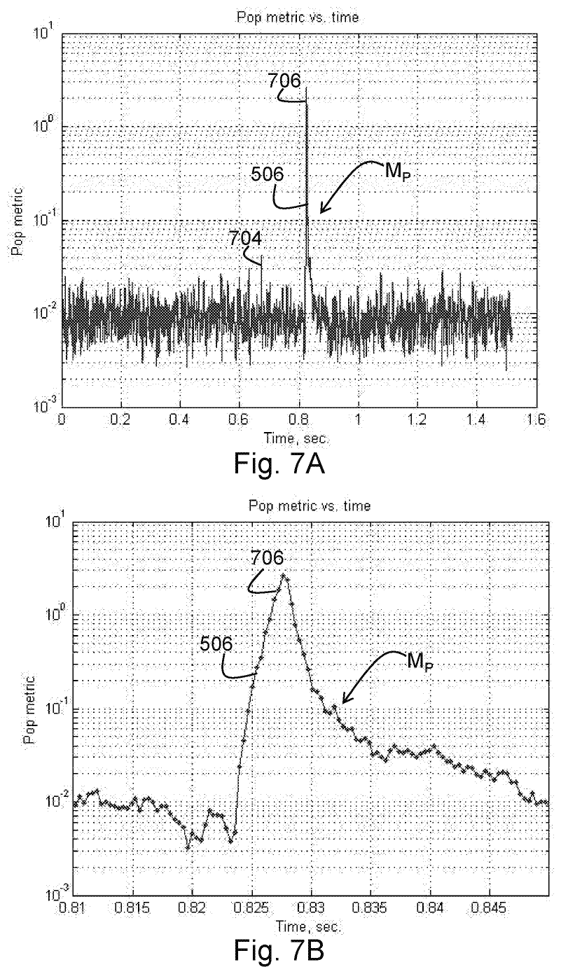

FIGS. 7A and 7B each show a pop metric consistent with at least one embodiment of this disclosure.

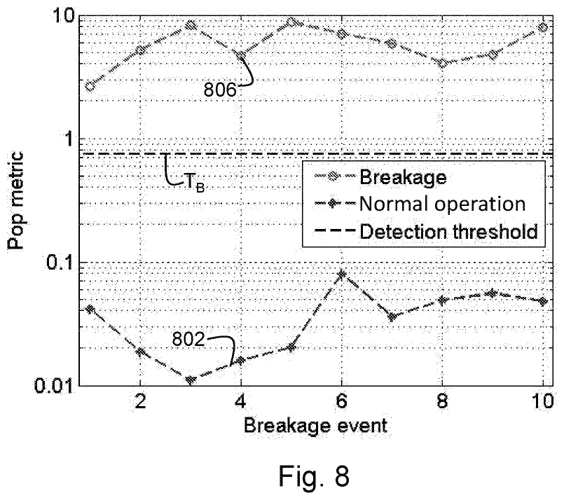

FIG. 8 shows pop metrics for ten breakage events consistent with at least one embodiment of this disclosure.

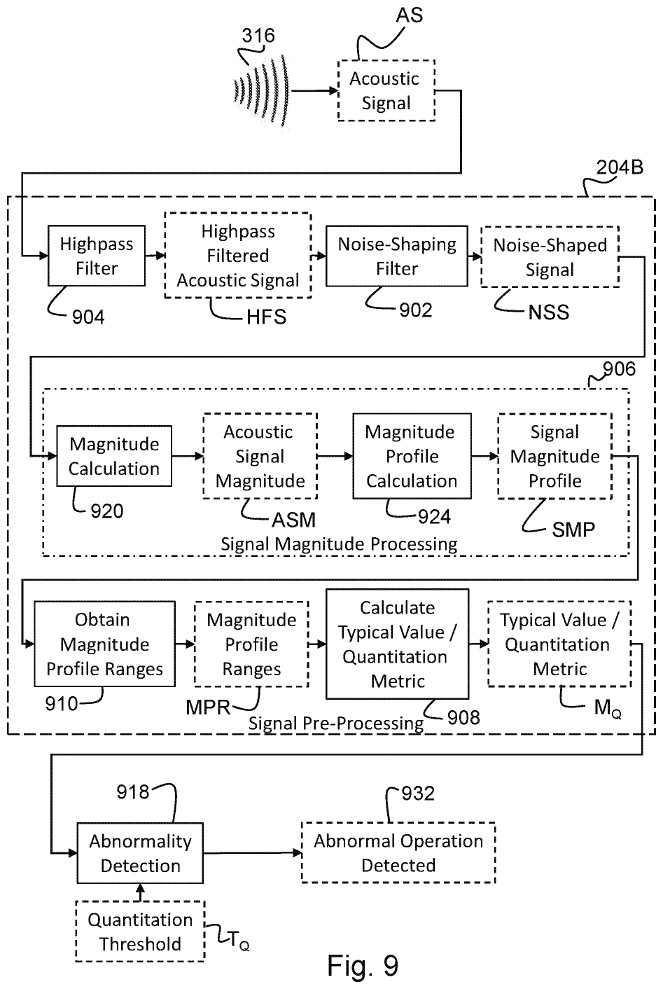

FIG. 9 shows a block diagram of a second algorithm consistent with at least one embodiment of this disclosure.

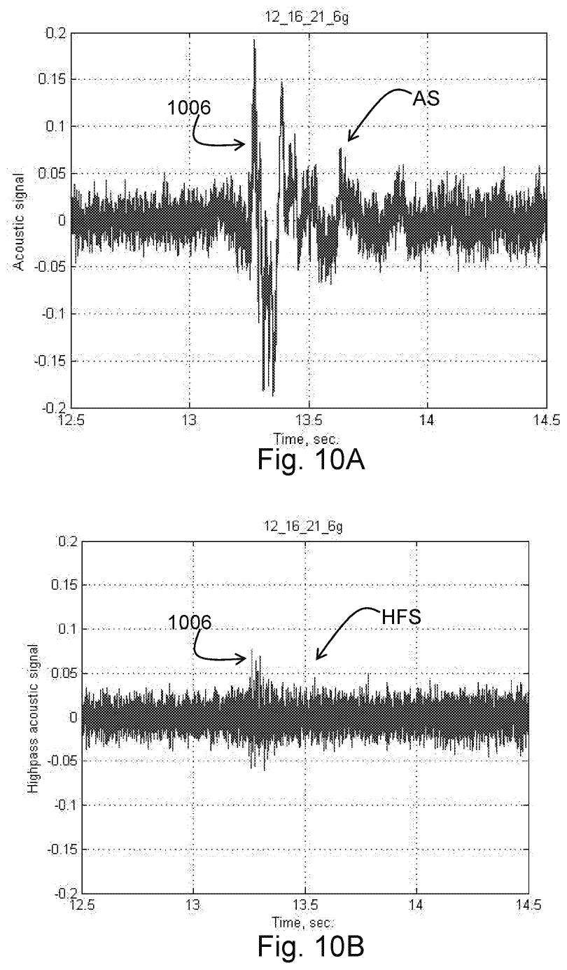

FIG. 10A shows a plot of an acoustic signal consistent with at least one embodiment of this disclosure.

FIG. 10B shows a plot of a highpass filtered acoustic signal consistent with at least one embodiment of this disclosure.

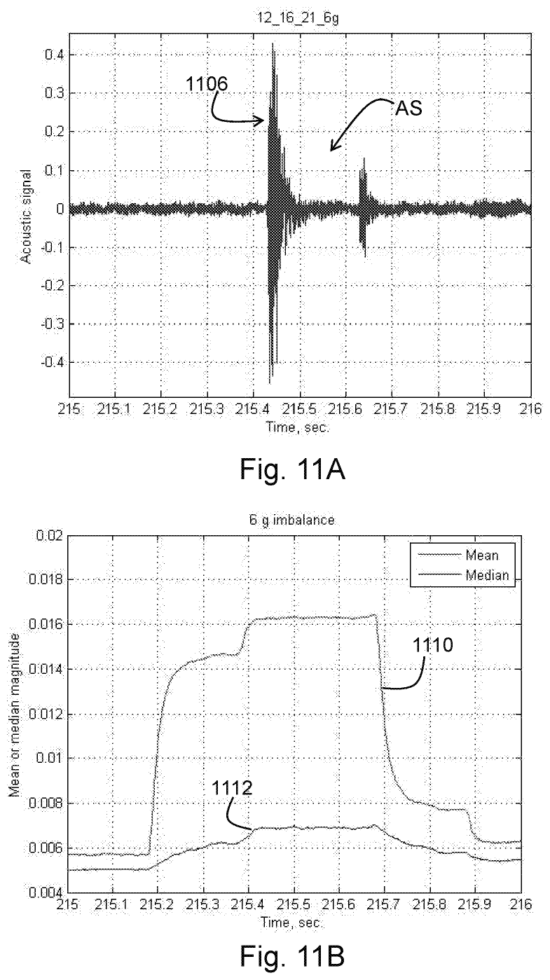

FIG. 11A shows a plot of an acoustic signal consistent with at least one embodiment of this disclosure.

FIG. 11B shows a plot of a moving mean and a moving median of a signal magnitude profile consistent with at least one embodiment of this disclosure.

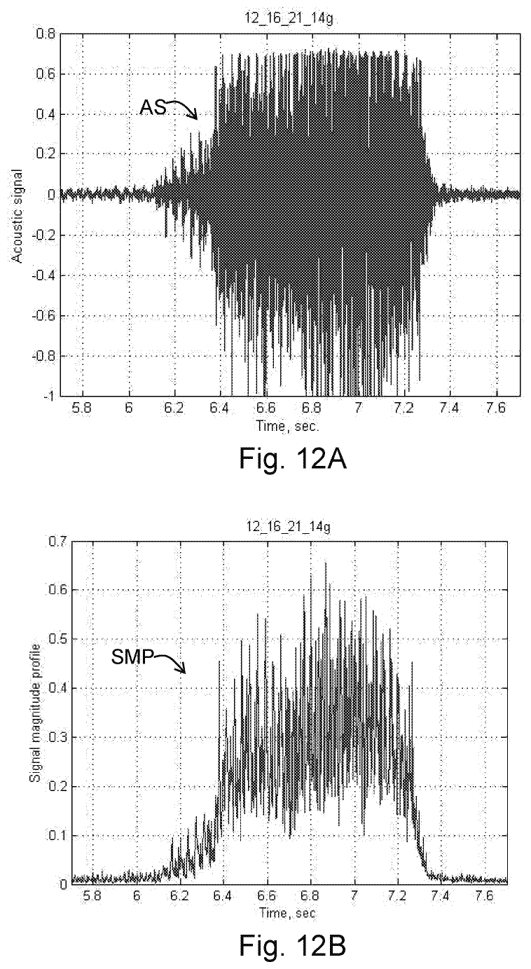

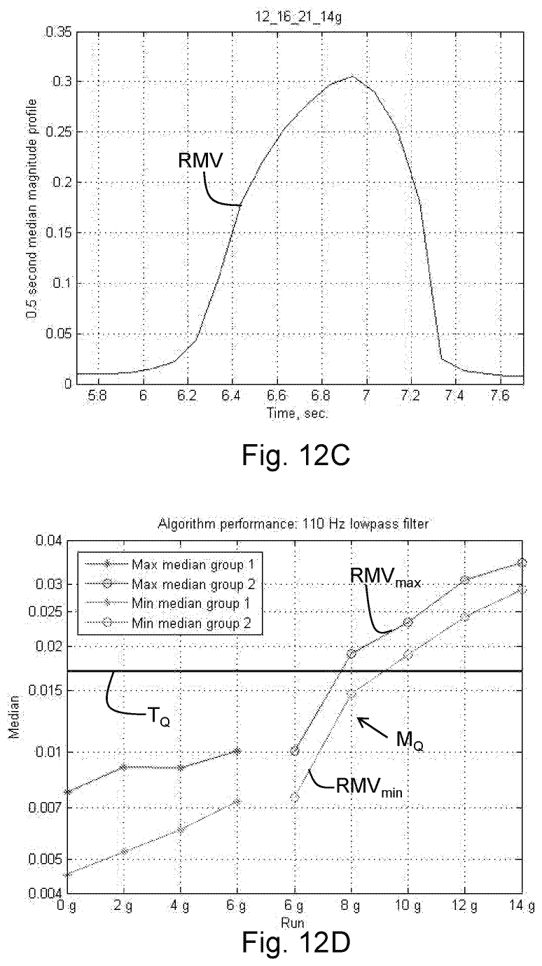

FIG. 12A shows a plot of an acoustic signal from an imbalanced rotor consistent with at least one embodiment of this disclosure.

FIG. 12B shows a plot of a signal magnitude profile from an imbalanced consistent with at least one embodiment of this disclosure.

FIG. 12C shows a plot of a representative magnitude value from an imbalanced rotor consistent with at least one embodiment of this disclosure.

FIG. 12D shows a plot of a quantitation metric of different imbalanced rotors consistent with at least one embodiment of this disclosure.

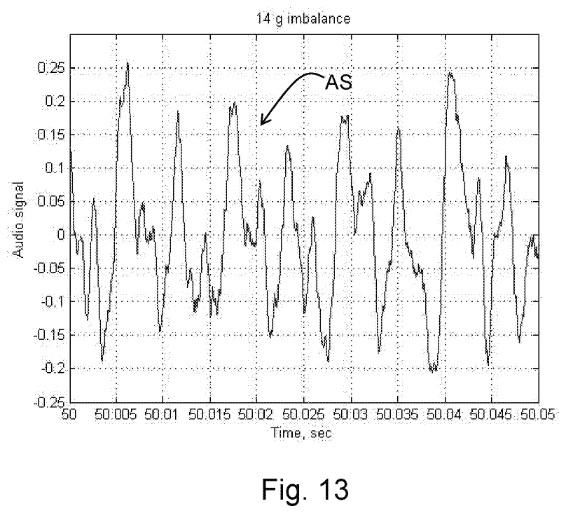

FIG. 13 shows a plot of an acoustic signal of an imbalanced rotor consistent with at least one embodiment of this disclosure.

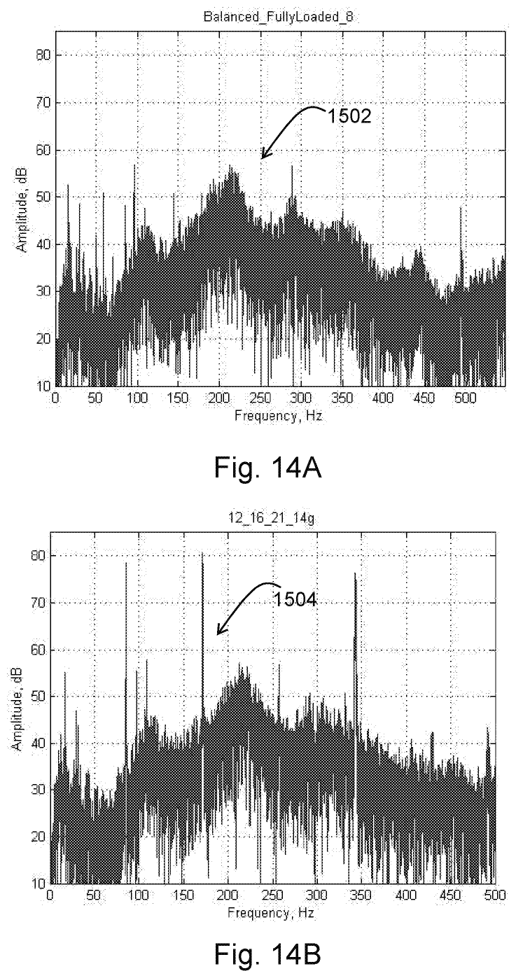

FIG. 14A shows a plot of a Fourier spectrum of an acoustic signal of a balanced rotor consistent with at least one embodiment of this disclosure.

FIG. 14B shows a plot of a Fourier spectrum of an acoustic signal of an imbalanced rotor consistent with at least one embodiment of this disclosure.

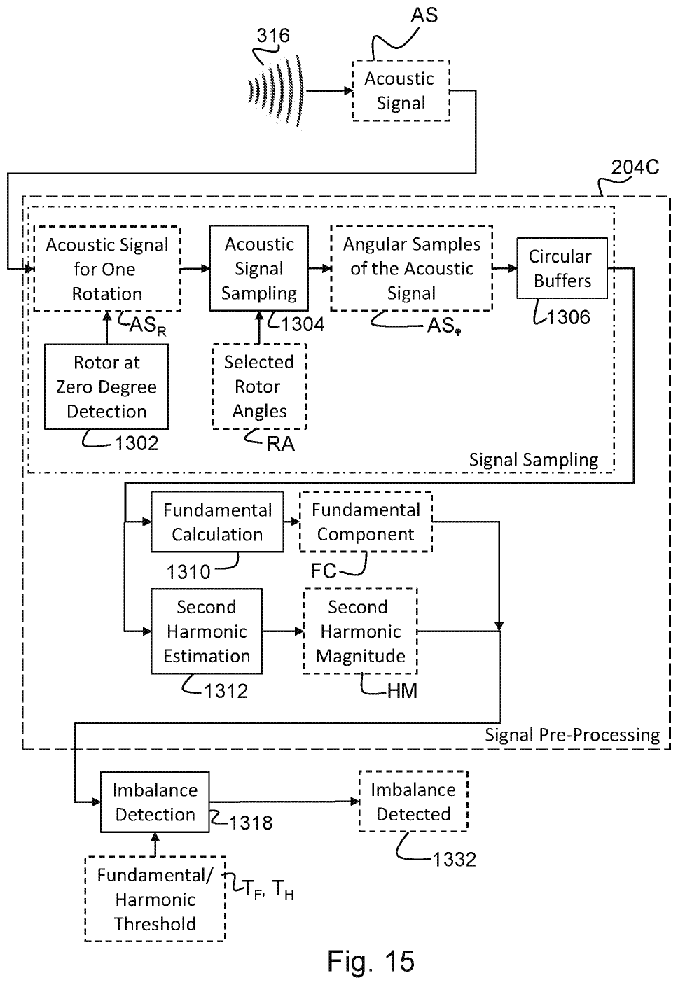

FIG. 15 shows a block diagram of a third algorithm consistent with at least one embodiment of this disclosure.

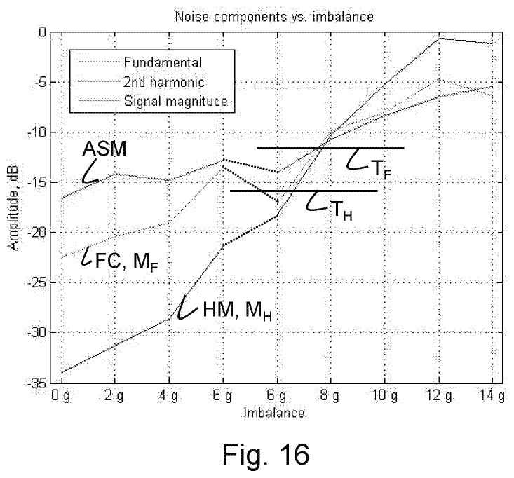

FIG. 16 shows a plot of each an acoustic signal magnitude, a fundamental component according to a fundamental metric, and a harmonic magnitude according to a harmonic metric of different imbalanced rotors consistent with at least one embodiment of this disclosure.

FIG. 1 shows an example schematic of a centrifuge 100 consistent with at least one embodiment of this disclosure. Centrifuge 100 may include a computing device 102, a drive component 104, a rotor 106, and an acoustic transducer 108.

Computing device 102 may be a component of centrifuge 100 as shown in FIG. 1 or may be a standalone computing device that is electrically coupled to a centrifuge to send and receive signals as disclosed herein. As shown in FIG. 1, computing device 102 may include one or more processors 110 (e.g., a processing unit, a processing unit system, a microprocessor, a microcontroller) and a memory 112 (e.g., one or more of the following: a memory unit, random access memory (RAM), flash memory, disk drive). Memory 112 may include a software module 114 and/or acoustic data 116. While executing on processor 110, software module 114 may perform processes for detecting abnormalities in the operations of centrifuge 100 and controlling centrifuge 100, including, for example, one or more stages included in a method 200 described herein with respect to FIG. 2. Processor 110 also may include a user interface 118, a communications port 120 (e.g., comm. port), and an I/O device (e.g., input/output device) 122.

Drive component 104 may include one or more motors that may turn rotor 106. For example, drive component 104 may be a DC motor coupled to rotor 106 directly or via a belt. Activation of drive component 104 via a signal from processor 110 may cause the motor to spin rotor 106. Drive component 104 may also drive one or more components of centrifuge 100. For example, drive component 104 may include circuitry to power one or more motors, robotic arms, etc. that may autonomously load sample containers (e.g., tubes 124, sample tubes, test tubes, reaction vessels, cups, vials, bottles) into rotor 106 for various procedures.

While FIG. 1 shows a single processor 110, consistent with embodiments disclosed herein, systems may include more than one processor and/or computing device that implement the methods disclosed herein. For example, a first processor and/or a first computing device may be used to control a centrifuge, and a second processor and/or a second computing device may obtain and process the acoustic data 116, detect abnormalities, and generate, e.g., a termination signal to the first processor and/or first computing device for halting the centrifuge 100 when abnormalities are detected.

Rotor 106 may be metal, polymer, ceramic, or any combination thereof material that defines one or more cavities for receiving at least one tube 124. During operations the tubes 124 may be loaded into the rotor 106, such as via the drive component 104, and spun around to separate the components of a mixture within the tubes 124.

Rotor 106 may also have bearings and other components to facilitate rotation. Over time, the bearings or other components may become worn. As a result, rotation of rotor 106 may be hindered. The worn bearings may cause a vibration, which may appear as an imbalance or abnormality, in rotation of rotor 106. As disclosed herein, worn bearings may cause detectable changes in an acoustic signal captured by acoustic transducer 108. For example, worn bearings may cause an amplitude and/or frequency change, whether periodic, persistent or transient, in a sound produced as rotor 106 rotates that is detectable by acoustic transducer 108. Processor 110 may utilize software module 114 and acoustic data 116 to filter and/or process the acoustic signal captured by acoustic transducer 108 to determine an abnormality in the operation of centrifuge 100.

As further disclosed herein, during operation of centrifuge 100, a tube 124 may break in rotor 106. Such a tube breakage event may cause a momentary, or otherwise transient, amplitude and/or frequency change, such as an amplitude spike, in a sound produced as rotor 106 rotates that is detectable by acoustic transducer 108. Processor 110 may utilize software module 114 and/or acoustic data 116 to filter and/or process the acoustic signal captured by acoustic transducer 108 to determine the tube breakage, sometimes referred to as a tube breakage event.

As disclosed herein, software module 114 may include instructions that when executed by processor 110 cause processor 110 to detect a tube breakage event or other abnormality, terminate operations of centrifuge 100, and/or activate an alarm. For example, using software module 114 processor 110 may determine a tube 124 has broken during a procedure, terminate the procedure, and activate an alarm as disclosed herein.

Acoustic data 116 may include previously collected signal data, known waveforms for sounds produced during operations of centrifuge 100, threshold values and/or ranges of values that may indicate tube breakage and/or other abnormal operation conditions, etc. as disclosed herein. For example, acoustic data 116 may include past acoustic samples from previous operations of centrifuge 100 that may be used to compare currently collected (i.e., in real-time) acoustic samples collected via acoustic transducer 108 and/or I/O device 122 in order to determine when a tube breaks, bearings fail, etc. The past acoustic samples may be used to train and/or generate one or more models and/or metrics used to detect tube breakage events and/or abnormal operating conditions.

User interface 118 may include any number of devices that allow a user to interface with computing device 102 and/or centrifuge 100. Non-limiting examples of user interface 118 include a keypad, a display (touchscreen or otherwise), etc. User interface 118 may or may not be a component of the computing device 102. For example, it may be a component of the centrifuge 100, but not of the computing device 102. Furthermore, it may be a component of a second (not shown) computing system. For example, when a first computing system controls the centrifuge 100 and a second computing system receives the acoustic signals and detects the abnormality, user interface 118 may be component of the first computing system, the second computing system, or both.

The computing device 102 may be configured to generate an alarm signal in response to the detection of an abnormality. The alarm signal may be output at the user interface 118, e.g., as a sound and/or as visual signal.

Communications port 120 may allow computing device 102 and/or centrifuge 100 to communicate with various information sources and devices, such as, but not limited to, remote computing devices such as servers or other remote computers maintained by testing facilities, mobile devices, peripheral devices, etc. Non-limiting examples of communications port 120 include Ethernet cards (wireless or wired), Bluetooth transmitters and receivers, near-field communications modules, universal serial bus (USB) ports, etc.

I/O device 122 may allow computing device 102 and/or centrifuge 100 to receive and output information. For example, I/O device 122 may include the acoustic transducer 108 and/or a port that allows acoustic transducer 108 to be connected to the computing device 102 and/or centrifuge 100. Non-limiting examples of I/O device 122 include USB ports, a parallel port, a camera (still or video), acoustic transducers, such as microphones, fingerprint or other biometric scanners, etc.

As disclosed herein, acoustic transducer 108 may include a microphone that may be located proximate centrifuge 100, such as proximate rotor 106, to capture sound waveforms (e.g., acoustic signal) during operation of the centrifuge 100. The waveform may be filtered and converted to digital form to facilitate analysis. For example, software module 114 in conjunction with processor 110, and/or other digital signal processing (DSP) algorithms may be used to transform the captured waveforms to a digital form and analysis as disclosed herein. While the transformation is disclosed herein as being performed via software module 114, acoustic data 116, and processor 110, embodiments disclosed herein may include standalone electronic hardware to perform the transformations and/or analysis. Software module 114 may operate with digital acoustic signal, whereas standalone electronic hardware may operate on an analog acoustic signal (e.g., voltage). Both digital acoustic signal and analog acoustic signal are considered to be acoustic signal.

As disclosed herein, during operation, software module 114 and/or acoustic data 116 may be used to detect tube breakage events or other abnormal operations of centrifuge 100 by distinguishing between normal operating noises and abnormal operating noises that may indicate a breakage event, worn bearings, etc. For example, abnormal operations such as tube breakage events tend to produce a sudden, loud, sound. Worn bearings or an imbalance in rotor 106 may produce a periodic or continuous spectrum of sound that deviates from a known sound of rotor 106 rotating.

Thus, the computing device 102, in particular the software module 114 and/or acoustic data 116, may be used to detect a tube breakage event by, e.g., detecting a simultaneous occurrence of a sudden increase in sound level and a peak sound level being louder than normal.

Furthermore, the computing device 102, in particular the software module 114 and/or acoustic data 116, may be used to detect an abnormal operation of the centrifuge by, e.g., detecting a continuous deviation from known sound levels equated with normal centrifuge operations, e.g., an elevated sound level.

Even more, the computing device 102, in particular the software module 114 and/or acoustic data 116, may be used to detect an abnormal operation of the centrifuge such as an imbalanced rotation by, e.g., detecting a periodic deviation from known sound levels equated with normal centrifuge operations.

Consistent with embodiments disclosed herein, any of the above deviations from normal operation may be monitored independently or in combination. Still consistent with embodiments disclosed herein, any deviation from normal operation may be monitored to detect a situation wherein a specific metric derived from the acoustic signal may be higher than a corresponding metric-specific threshold. Though imbalance may cause a periodic signal, a squealing bearing might not be periodic, but both may cause at least one of the metrics and/or an average signal to be excessive. The actions of the software module 114 are discussed further with reference to, e.g., FIGS. 4, 9, and 13.

FIG. 2 shows an example method 200 consistent with this disclosure for detecting tube breakage events and/or other abnormal operations of a centrifuge, such as centrifuge 100 shown in FIG. 1. Method 200 may begin at stage 202 where an acoustic signal may be received. For example, an acoustic signal may be received via a sound transducer, such as acoustic transducer 108, located proximate to a rotor, such as rotor 106, of a centrifuge, such as centrifuge 100. The acoustic signal may be received continuously or intermittently. For instance, the sound transducer may constantly output a voltage that is received by a processor, such as processor 110. The sound transducer may output a voltage intermittently, such as once every millisecond, a rate of 32 kHz, etc., that may be received by the processor 110 and/or the computing device 102.

The received acoustic signal may be pre-processed at step 204. For example, the acoustic signal may be pre-processed via a pre-amp and an analog-to-digital converter (ADC). Pre-processing the acoustic signal may include filtering noise from the acoustic signal via a noise shaping filter. Other pre-processing activity may include normalizing the acoustic signal by using past valves of the acoustic signal or known values. For example, a current value of the acoustic signal may be divided by a value of the acoustic signal from a time period, such as about 10 milliseconds, prior to the current time to determine how rapidly the magnitude of the signal is changing. Still consistent with embodiments disclosed herein, particular values, or even value pairs, triplets, etc., of a signal may be compared to adjacent values, value pairs, triplets, etc., such as a preset time, such as 1, 5, 10, etc. ms, apart from one another to determine a rise rate. For example, a differentiating filter may be used to compare values of the acoustic signal.

An abnormality in the acoustic signal may be detected at step 206. The abnormality in the acoustic signal may be associated with an abnormality in an operation of the centrifuge 100. For example, the abnormality in the acoustic signal may be associated with a tube breakage event. For instance, when a tube breaks, there may be a momentary spike in the acoustic signal received by the sound transducer. The momentary spike may be an amplitude change. Thus, detecting the abnormality in the acoustic signal may include correlating the abnormality in the acoustic signal to a sound associated with a tube breakage event, i.e., the spike in the amplitude.

The abnormality in the acoustic signal may be associated with an imbalanced rotor and/or worn bearings in the rotor. For instance, an imbalanced rotor or worn bearings in the rotor may cause fluctuations in the acoustic signal. The fluctuations may be periodic and correspond to the speed of the rotor. For example, the imbalance rotor may cause a knocking sound that is periodic and has a period corresponding with the RPM of the rotor. Thus, detecting the abnormality in the acoustic signal may include detecting a periodic fluctuation in the acoustic signal received by the sound transducer. Stated another way, the periodic fluctuation in the acoustic signal may be correlated to an imbalance in the rotor by the period of the knocking sound. For periodic sounds, detecting the abnormality may include detecting a frequency change, such as a periodic spike in frequency, amplitude, etc., in the acoustic signal. For increased sound levels, detecting a change in magnitude spacing and/or the peak magnitude, including a change in the signal magnitude profile (cf., e.g., FIG. 4), may indicate an imbalance and/or other potential malfunction.

As disclosed herein, the acoustic signal may be a voltage signal and detecting the abnormality in the acoustic signal may include detecting a momentary spike in the voltage. The momentary spike may be associated with an amplitude change in the voltage associated with tube breakage events. For instance, the tube breakage event may be associated with a momentary high pitch pop or other sound when the tube breaks. This high pitch pop may result in a momentary spike in the voltage, thus indicating a tube breakage event.

When the abnormality has been detected, centrifuge operations may be discontinued, cf. step 208. Discontinuing centrifuge operations may include issuing a termination signal 212 for halting the centrifuge 100. Discontinuing centrifuge operations may include transmitting the termination signal 212 to a drive component, such as drive component 104, of the centrifuge 100. The termination signal 212 may cause the drive component to shut down and thus stop the rotor from spinning. For example, the termination signal 212 may activate a relay that cuts power to the drive component to stop the rotor from spinning. Discontinuing centrifuge operations may include halting the transmission of a signal to the drive component. For example, upon detecting the abnormality, power to the drive component may be terminated to stop the rotor from spinning or a halt signal may be transmitted, which directly or indirectly controls drive component 104.

Alternatively or additionally, when the abnormality has been detected, an alarm may be activated, cf. step 210. Activating the alarm may include generating an alarm signal and/or activating one or more lights, which may be connected to I/O device 122, to provide a visual alert to an operator that may be in the vicinity of the centrifuge 100. Activating the alarm may include activating an audible alarm, such via a speaker, i.e., I/O device 122. Activating the alarm may include transmitting a message, such as a text message, email message, etc. to a designated contact. For example, activating the alarm may result in an email message being sent to one or more technicians working in a laboratory. In systems where more than one computing devices are used, a message may be transmitted to a processor that operates centrifuge 100 and that processor may then cause a message to be displayed, light turned on, etc.

While method 200 has been described in a particular order and having particular stages, one skilled in the art will understand in view of this disclosure that stages may be omitted and/or rearranged without departing from the scope of this disclosure. For example, any one or more of pre-processing of the acoustic signal (204), discontinuing centrifuge operations (208), and/or activating an alarm (210) may be omitted. As another example, an alarm may be activated (210) prior to discontinuing centrifuge operations (208). For instance, an alarm may be activated (210) and a technician may determine if a false positive has been indicated. If a false positive has been indicated, the data may be saved as part of acoustic data 116 and used to train models as disclosed herein. If the technician does not check on centrifuge operations within a certain time frame, such as 5 minutes, then centrifuge operations may be discontinued (208).

FIG. 3 shows a schematic of a processing system 300 consistent with at least one embodiment of this disclosure. Processing system 300 may be a component of centrifuge 100 and executed using computing device 102, e.g., processor 110, software module 114, and/or acoustic data 116, etc. Processing system 300 may include a microphone 302, a circuit 304 that may include a pre-amp 306 and an analog to digital converter 308, a digital processing unit 310 that may include a micro processing unit 312 that may execute at least one metric algorithm 314, e.g., a pop metric algorithm.

FIG. 4 shows a block diagram of a pop metric algorithm that may be executed as metric algorithm 314. During operation, a sound wave 316 may be produced by a tube breakage event 318 (cf. FIG. 3). Sound wave 316 may be captured by microphone 302 and supplied as an input to circuit 304. Pre-amp 306 may amplify a signal generated by microphone 302. For example, pre-amp 306 may amplify a voltage generated by microphone 302 upon capturing sound wave 316. After amplifying the signal, analog to digital converter 308 may convert the analog signal (i.e., the voltage), to a digital acoustic signal AS. By converting the voltage to a digital acoustic signal AS, losses may be avoided during further processing of the signal.

After converting the analog acoustic signal to a digital waveform, one embodiment of pre-processing 204A (cf. FIG. 2) may be performed to assist in detecting abnormalities and/or tube breakage events 318 (cf. FIG. 3). The pre-processing 204A shown in FIG. 4 is one embodiment of the pre-processing step 204 shown in FIG. 2.

For example, prior to further processing, a noise-shaping filter 402 (cf. FIG. 4), such as lowpass, highpass, or other equalizing filtering may be applied to the acoustic signal AS. Using the noise-shaping filter may allow for portions of the frequency spectrum having a high signal-to-noise ratio (S/N) to be emphasized, and/or portions of the frequency spectrum having a lower S/N to be attenuated. As disclosed herein, with reference to the signal-to-noise ratio, “signal” may be the sound of a tube breakage event 318, and “noise” may be the normal operating noise produced by centrifuge 100. The noise-shaping filter may make the sound of a tube breakage event 318 and/or other abnormal signals easier to distinguish from normal operating noise. Other examples of pre-processing 204A and/or 204 may include mixing outputs of the microphones in an array of microphones to form a single signal, or comparing the outputs of microphones close to rotor 106 with that of microphones farther from rotor 106 to distinguish between sounds originating within the rotor 106 from sounds generated externally (cf. FIG. 1).

During a tube breakage event 318, there may be a rapid increase in sound level. This increase may have a duration of several milliseconds. However, the acoustic signal also may contain high frequency components, both under normal operation and during breakage, which may cause rapid fluctuations in the acoustic signal within a time period of less than a millisecond. Thus, it may be helpful for pre-processing 204A to include a signal magnitude processing 406 which may include 1) magnitude calculation 420, which calculates a signal indicative of the magnitude of the acoustic signal AS (e.g., an acoustic signal magnitude ASM, a power such as acoustic signal squared, the absolute value of the acoustic signal, or other measure of the magnitude of the acoustic signal), then 2) a magnitude profile calculation 424 which may create a signal magnitude profile SMP by smoothing the acoustic signal magnitude ASM to attenuate fluctuations that occur in less than a millisecond while preserving fluctuations on a time scale corresponding to the power rise of a tube breakage event 318. For example, embodiments disclosed herein may include smoothing the acoustic signal magnitude ASM by calculating the moving average of the acoustic signal magnitude ASM over a given window of time, such as a 1-2 to 20 millisecond window.

As an example, embodiments disclosed herein may include a rise rate determination 412, which calculates a signal rise rate SRR by comparing the signal magnitude profile SMP at a present time, with the signal magnitude profile SMP in the past, such as about 1 to 20 milliseconds in the past, for example such as 10 milliseconds in the past, shorter for embodiments where the tube breakage event 318 causes a more rapid increase in the signal magnitude profile SMP, or longer for embodiments where the tube breakage event 318 causes a less abrupt increase in the signal magnitude profile SMP. The signal rise rate SRR is the result of the comparison of values of the signal magnitude profile SMP. The comparison may involve calculating a quotient of the signal magnitude profile SMP at the present time, divided by the signal magnitude profile SMP in the past. If the quotient is large, such as half an order of magnitude or greater than unity, a rapid rise in the signal magnitude profile SMP may be considered present. Alternatively, other methods of comparison may be used to detect a rapid rise in the signal magnitude profile SMP. For instance, the values of the signal magnitude profile SMP at two or more times close to or at the present time may be compared. A differentiating filter could be used to detect a rapid rise.

It is possible that rapid random fluctuations in normal-operation noise may be present, causing the comparison of signal magnitude profile SMP values to generate signal rise rate SRR values indicative of a rapid rise in the signal magnitude profile SMP, but not associated with a tube breakage event 318 or other abnormality of centrifuge operation. This is especially the case if the signal magnitude profile SMP at, for example, about 10 milliseconds ago happens to be quieter than usual. Then there could be a rapid rise in signal magnitude profile SMP not associated with a tube breakage event. Thus, tube breakage events 318 are more reliably detected by the combination of the present-time signal magnitude profile SMP being at a high level, accompanied by a value of the signal rise rate SRR indicative of a rapid rise in the signal magnitude profile SMP. This may be monitored by a pop metric M_{P} (“pop” named after the characteristic popping sound of a breaking tube in one embodiment) which incorporates the signal rise rate SRR and the signal magnitude profile SMP. For instance, the signal rise rate SRR may be multiplied by the signal magnitude profile SMP. At a breakage event, both the signal rise rate SRR and the signal magnitude profile SMP may be large, giving a large pop metric M_{P}. The calculation of the pop metric M_{P} may be the last step of the pre-processing step 204A.

A breakage threshold T_{B} may be established for the pop metric M_{P}. The breakage threshold T_{B} may be based on typical values of the pop metric M_{P} during normal operation, and at tube breakage events. Typical values of the pop metric M_{P} during normal operation may be calculated real-time, possibly based on the pop metric M_{P} during a certain amount of time before the present, or on a history of the pop metric M_{P} for a particular instrument, or could be pre-determined based on measurements coming from a study. Stated another way, the thresholds may be based on known sound levels and/or deviations from known sound levels for normal operations of centrifuge 100. Since tube breakage events 318 should be rare, typical pop metric M_{P} values during tube breakage events 318 may need to be predetermined, based on measurements from a study that collected sound levels for tube breakage events 318 that may occur during operations of centrifuge 100. The threshold T_{B} may then be determined to be high enough to provide enough margin to prevent false positives during normal operation, but low enough to reliably detect tube breakage events 318. Other abnormalities in the operation of centrifuge 100 may be detected by applying a different metric described below.

In other words, acoustic signal AS may be processed using digital processing unit 310 and metric algorithm 314 (cf. FIG. 3). As part of processing acoustic signal AS, the noise shaping filter 402 and signal magnitude processing 406 may be applied to acoustic signal AS (cf. FIG. 4). Examples of noise shaping filter 402 may include lowpass, highpass, bandpass and equalizing filters. The processing may filter background noise, which is generally low frequency, from tubes breaking, which is generally a higher frequency.

Signal magnitude processing 406 may include transforming the noise-shaped acoustic signal NSS from noise-shaping filter 402 to the acoustic signal magnitude ASM. This may be done by calculating the absolute value, the square, or other means. The purpose is so that the sign of the acoustic signal magnitude ASM does not fluctuate between positive and negative, but remains the same sign. Signal magnitude processing 406 may further include smoothing the acoustic signal magnitude ASM, producing the signal magnitude profile SMP. This may attenuate fluctuations which may be much shorter in duration than the duration of the acoustic spike caused by a tube breakage event 318, whereas the acoustic spike is not significantly attenuated.

A tube breakage event 318 may average about 5-50 ms in duration. Variations in background may average less than 1 ms to about 3 ms in duration, depending on the embodiment and the type of noise-shaping filter 402 used. To calculate the pop metric M_{P}, a delay 410 may be used to determine the signal rise rate SRR, sometimes simply referred to as “rise rate”. For example, a magnitude profile (i.e., an output of the signal magnitude processing 406, which may be the acoustic signal AS, noise-shaped acoustic signal NSS, acoustic signal magnitude ASM, and/or signal magnitude profile SMP), may be delayed by a time frame, such as 9 ms, and the magnitude profile at the present time and the delayed magnitude profile may be compared to determine rise rate SRR. For example, a value, such as the magnitude profile (e.g., the signal magnitude profile SMP) from a current time, t, and a time from 9 ms prior to t, t−9 ms, may be compared, to determine the rise rate SRR. The comparison may be the ratio of the signal magnitude profile SMP at t to the signal magnitude profile SMP at the prior time. Pop metric M_{P} may be determined based on the magnitude profile and rise rate SRR. For instance, the pop metric M_{P} may be signal magnitude profile SMP multiplied by rise rate SRR. If pop metric M_{P} is too high, then a tube breakage event 318 may have occurred. For instance, if pop metric M_{P} is greater than the breakage threshold

T_{B}, a breakage event is detected 432.

It may be advantageous to compare values of the signal magnitude profiles SMP or acoustic signal magnitudes ASM, rather than either the acoustic signal AS or noise-shaped acoustic signals NSS because the acoustic signals AS and NSS fluctuate positive and negative, which may make the comparison more difficult. The signal magnitude profile SMP and the acoustic signal magnitude ASM are always positive, and the signal magnitude profile SMP involves smoothing, so the comparison is more likely to be meaningful, rather than being based on whether the time happens to be at a crest or near a zero crossing.

Tube breakage events 318 may also cause an imbalance due to weight distribution changes. For example, if a tube breaks, the tube may shift from a distributed state to concentrated at the bottom of a cavity defined by rotor 106 thereby causing a weight shift that creates an imbalance in rotor 106.

To detect tube breakage events and/or other abnormal operations such as an imbalance in rotor 106, other input devices, such as vibration sensors, may be used instead of or in conjunction with acoustic transducer 108. For example, a piezoelectric sensor may be attached to centrifuge 100, drive component 104, etc. and output a voltage in response to stresses placed on a component of centrifuge 100 during operations. The voltage could be processed, including preprocessing as disclosed herein, to determine when a vibration is present by comparing signal magnitudes.

Though the signal magnitudes disclosed herein may be the signal magnitude profile SMP, analysis could be performed that operates on the acoustic signal magnitude ASM, the noise-shaped acoustic signal NSS, and/or the acoustic signal AS. Spectrograms are a non-limiting example of such. Spectral analysis, including Fourier transforms, may be used to improve selectivity. Digital filtering, including lowpass, highpass, bandpass, and spectral shaping filters, may be used to improve selectivity as well.

As disclosed herein, deviations from known or expected signal values by the breakage threshold T_{B} may be used to detect tube breakage events 318 or other abnormal operations. For example, the breakage threshold T_{B} between tube breakage events 318 vs. normal operation may be determined real-time, based on current measurements, or could be predetermined. To determine or otherwise derive the known or expected signal values, machine learning and/or artificial intelligence could be employed with or without these means to distinguish between tube breakage events and normal operation. For instance, signals received and analyzed during past operations may be used to train and/or develop one or more models. The models may include inputs such as rotor speed (RPM), substance in the tubes, the material the tubes are made of, the dimensions of the tubes, the length of time rotor 106 is expected to rotate, etc. Using the various inputs, an expected signal may be determined and used for comparison to signals received via acoustic transducer 108 and/or I/O device 122.

FIGS. 5A and 5B each show a plot of acoustic signal AS vs. time consistent with at least one embodiment of this disclosure. Acoustic signal AS may be the data collected from a transducer, such as acoustic transducer 108. As shown in FIG. 5A, acoustic signal AS may include an abnormality 506, which may be associated with a tube breakage event 318. Tube breakage events 318 typically cause a sharp spike in the acoustic signal AS, sounding to a human like a pop. FIG. 5B, which shows 40 ms of acoustic signal AS near abnormality 506, shows the rapid fluctuations in the signal which may complicate the analysis discussed herein.

FIGS. 5C and 5D each show a plot of noise-shaped acoustic signal NSS consistent with at least one embodiment of this disclosure. Noise-shaped acoustic signal NSS may be the output of the noise-shaping filter 402. As shown in FIG. 5C, noise-shaped acoustic signal NSS may include an abnormality 506, which may be associated with a tube breakage event 318. FIG. 5D, which shows 40 ms of noise-shaped acoustic signal NSS near abnormality 506 shows a greater difference between the abnormality 506 caused by the tube breakage event 318 and the normal centrifuge operation 526 preceding the abnormality 506 than is displayed in FIG. 5B, which shows the plot of the acoustic signal AS prior to the noise-shaping filter 402 being applied. Thus, the noise-shaping filter 402 emphasizes this signal feature of the acoustic signal AS relevant for the detection of tube breakage event 318.

The noise-shaping filter may be a highpass filter. The noise-shaped acoustic signal NSS at any given time for the plots shown in FIGS. 5C and 5D was obtained by computing the acoustic signal AS at that time, minus the acoustic signal AS at the immediately previous time. The sampling rate was 44.1 KHz, so the acoustic signal AS at time t, minus the acoustic signal AS at time t−1/44100 s was computed. This particular highpass filter was chosen because it involves very little computation yet provides sufficient highpass effect to facilitate further processing. The amount of computation may be an important consideration when the rate of the acoustic data AS is high—in this example, 44,100 values per second.

FIG. 5C shows the noise-shaped acoustic signal NSS corresponding with a tube breakage event 318 and with normal centrifuge operation 526. In this example, the acoustic signal AS in the vicinity of the tube breakage event 318 has a higher proportion of high-frequency components than does the acoustic signal AS corresponding with normal operation. Hence, the noise-shaping filter 402 applied in this example emphasizes the high frequency components and de-emphasizes the low-frequency components. Thus, the distinction between the noise-shaped acoustic signal NSS associated with a tube breakage event 318 vs. with normal centrifuge operation 526 is more pronounced than the distinction between the original acoustic signal AS associated with the tube breakage event 318 vs. with normal centrifuge operation as shown in FIGS. 5A and 5B.

FIGS. 5E and 5F each show a plot of acoustic signal magnitude ASM consistent with at least one embodiment of this disclosure. Acoustic signal magnitude ASM may be the output of magnitude calculation 420. As shown in FIG. 5E, acoustic signal magnitude ASM may include an abnormality 506, which may be associated with a tube breakage event 318. FIG. 5F, which shows 40 ms of acoustic signal magnitude ASM near the abnormality 506 shows that all of the values of acoustic signal magnitude ASM are greater or equal to zero. This is in contrast with the acoustic signal AS (cf. FIG. 5B) and noise-shaped acoustic signal NSS (cf. FIG. 5D), where values rapidly fluctuate between positive and negative. Subsequent algorithm steps may be facilitated when all the acoustic signal magnitude values ASM are of the same sign as shown in FIGS. 5E and 5F.

FIGS. 6A and 6B each show a plot of signal magnitude profile SMP consistent with at least one embodiment of this disclosure. Signal magnitude profile SMP may be the output of the magnitude profile calculation 424 shown in FIG. 4. Signal magnitude profile SMP shown in the plots shows the smoothing of rapid fluctuations in the signal shown in FIG. 5F. The abnormality 506 shown in FIGS. 5E and 5F is shown as a smoother curve 606 having an identifiable rise 608 and decline 610. Rise 608 and decline 610 are easily identifiable and therefore can be used to detect a tube breakage event 318.

The signal magnitude profile SMP may be obtained by decimating, then smoothing the acoustic signal magnitude ASM. In this example, the acoustic signal magnitude ASM has a sampling rate of 44.1 KHz. The acoustic signal magnitude ASM is transformed into a decimated signal magnitude by binning the acoustic signal magnitude ASM into adjacent groups of 16 consecutive values each, then the average of these 16 values is computed. For instance, the 1^{st} value of the decimated signal magnitude is the average of the 1^{st} through 16^{th} values of the acoustic signal magnitude ASM, the 2^{nd} value of the decimated signal magnitude is the average of the 17^{th} through 32^{nd} values of the acoustic signal magnitude ASM, and so forth for the rest of the acoustic signal magnitude ASM data. The decimated signal magnitude represents the acoustic signal magnitude ASM yet is a smaller data set than the acoustic signal magnitude ASM. The sampling rate of the decimated signal magnitude is 44.1 KHz/16=2.756 kHz. Utilizing the decimated signal magnitude enables subsequent calculations to occur at 2.756 kHz instead of 44.1 KHz. Because the sampling rate is slower, decimation reduces the amount of computation required.

Next, the signal magnitude profile SMP was obtained by applying a 5-point moving average to the decimated signal magnitude obtained as described above. The signal magnitude profile SMP is shown in the plots of FIGS. 6A and 6B. Both the decimation and the 5-point moving average provide a smoothing operation to their respective targets. The smoothing is especially evident when comparing FIGS. 5F and 6B. These figures show 40 mSec of data. The acoustic signal magnitude ASM shown by FIG. 5F has many rapid fluctuations which may make analysis difficult. By contrast, the signal magnitude profile SMP shown in FIG. 6B has a clearly identifiable rise, peak, and decline. Using the signal magnitude profile SMP as input to subsequent algorithm steps to detect tube breakage events 318 may, thus, greatly simplify the algorithm.

In another embodiment, the signal magnitude profile SMP is calculated from the acoustic signal magnitude ASM by decimating as described above only without the smoothing step. In yet another embodiment, the signal magnitude profile SMP is calculated from the acoustic signal magnitude ASM by smoothing as described above only without the decimating step.

In more general terms, the signal magnitude profile SMP may be calculated from the acoustic signal magnitude ASM by grouping a predetermined number of acoustic signal magnitude ASM values into one signal magnitude profile SMP value. This may be done in one, two, or more steps similar to the decimating and/or smoothing steps described above. Then, each signal magnitude profile SMP value may be calculated (e.g., as the mean) of about 5 to about 200 acoustic signal magnitude ASM values in at least one decimating and/or smoothing step. Preferably, about 50 to about 100 acoustic signal magnitude ASM values may be used to calculate one signal magnitude profile SMP value. The preferred range of used acoustic signal magnitude ASM values will likely depend on the specific embodiment. In particular, the embodiment will affect how sharp the tube-breakage noise is. For a very sharp noise, fewer acoustic signal magnitude ASM values may be best, and for a less sharp noise, more acoustic signal magnitude ASM values may be needed. There may be significant differences even between a prototype and a final instrumentation. It may be caused by the acoustics near the centrifuge, as affected by the instrument shell and materials. For example, in the specific embodiment described above 5×16=80 acoustic signal magnitude ASM values are used to calculate one signal magnitude profile SMP value in two distinct decimating and/or smoothing steps.

FIGS. 6C and 6D each show a plot of rise rate SRR consistent with at least one embodiment of this disclosure. Rise rate SRR may be the output of rise rate determination 412, cf. FIG. 4. Rise rate SRR averages about unity during normal operation, but is much larger during the rising portion of signal magnitude profile SMP at the abnormality 506.

For the plots shown in FIGS. 6C and 6D, the signal magnitude profile SMP is compared at two times spaced 4.4 ms apart. The time difference of 4.4 ms corresponds to 12 times the sampling interval of the signal magnitude profile; that is, 12/2.756 kHz=4.4 ms. The later of the two times may be considered to be the present time, or t. The earlier time is 4.4 ms in the past, or t−4.4 ms. The signal magnitude profile SMP values at t and t−4.4 ms are compared by dividing the signal magnitude profile SMP at t by the signal magnitude profile SMP at t−4.4 ms, yielding the rise rate SRR shown in FIGS. 6C and 6D. The shown rise rate SRR reaches its maximum value at about t=0.8276 s; at this time, the signal magnitude profile SMP value at t=0.8276 s is about 20 times larger than the signal profile magnitude SMP at t−4.4 ms=0.8232 s. FIG. 6B shows that the peak of the signal magnitude profile SMP occurs at about t=0.8276 s, and the rise to the peak starts at about t=0.8232 s.

FIGS. 7A and 7B show a plot showing a pop metric M_{P} consistent with at least one embodiment of this disclosure on a logarithmic scale. Pop metric M_{P} may be the output of the calculation of the pop metric step 408 shown in FIG. 4. For the plots shown in FIGS. 7A and 7B, the signal magnitude profile SMP as described above and shown in FIGS. 6A and 6B is used together with the rise rate SRR as described above and shown in FIGS. 6C and 6D. The tube breakage event 318 may correspond with an abrupt “pop” sound. This “pop” may cause both the signal profile magnitude SMP and the rise rate SRR to simultaneously have large values. The pop metric M_{P} is calculated by multiplying the signal magnitude profile SMP by the rise rate SRR. Simultaneous large values of the signal magnitude profile SMP and the rise rate SRR cause a very large value in the pop metric M_{P}

As shown in FIG. 7A, a maximum value 704 of pop metric M_{P} during normal operation is 0.034, whereas the maximum value 706 of pop metric M_{P} during the abnormality 506 caused by the tube breakage event 318 is approximately 3.0. Thus, the pop metric M_{P} may be nearly 100 times, or two orders of magnitude, greater during the tube breakage event 318 than during normal operation. This large difference allows tube breakage events 318 to be reliably distinguished from normal operation, as shown in FIG. 8.

FIG. 8 shows a plot of pop metrics M_{P} for different runs at normal operation 802 and for ten tube breakage events consistent with at least one embodiment of this disclosure. As shown in FIG. 8, pop metrics M_{P} may be calculated during normal operations (represented by line 802) and tube breakage events (line 806). Line 802 shows the maximum value of pop metric M_{P} during normal centrifuge operation for the different runs measured. The pop metrics M_{P} may be compared against a breakage threshold T_{B}. When the pop metric M_{P} exceeds the breakage threshold T_{B}, a tube breakage event 318 is indicated. The breaking threshold T_{B} clearly distinguishes the registered tube breakage events 318 from the normal operation. Thus, the pop metric M_{P} may be used to emphasize the momentary spike in the acoustic signal AS caused by tube breakage event 318.

Many further variations may be used to detect tube breakage events and/or abnormal operations. As disclosed herein, vibration could be used instead of sound. Power could be used to represent the signal's level (e.g., the acoustic signal magnitude) instead of or in conjunction with voltage. Other processing and/or metrics could be used to identify tube breakage events and/or other abnormalities. For example, transforming the signal, such as squaring, having a third input, sonograms, etc. In short, there are multiple ways the signal could be processed to identify tube breakage events and/or other abnormalities.

Using metric algorithm 314 (cf. FIG. 3) other abnormal operating conditions may be identified. For example, metric algorithm 314 may be used to determine when a rotor is out of balance based on changes. A rotor that is out of balance may not have sharp increases in acoustic signal AS like a tube breakage event. However, the imbalance may produce periodic rises. Thus, metric algorithm 314 may identify different peaks in cycles that could coincide with the RPM of the rotor. The period may get shorter as the rotor speeds up. Metric algorithm 314 may determine a periodic rise in acoustic signal AS that has a magnitude change. The frequency and changing peaks may be matched with known speeds of the rotor to detect an imbalance. While rotor speed may be helpful in detecting an imbalanced rotor, rotor speed is not needed. Detecting changes in frequency of the peaks with respect to changes in rotor speed may indicate an imbalanced rotor.

Additionally, an imbalanced rotor may cause the pop metric M_{P} to be generally elevated, but often not enough to provide a useful indicator of the imbalanced rotor. Thus, the pop metric M_{P} may be monitored, for example over several seconds, rather than identify periodic peaks. A periodic peak may be more informative and may be used to distinguish between tube breakage events 318 and other abnormality, such as an imbalance, malfunctioning bearing, and/or other mechanical malfunctions that may or may not be associated with tube breakage events.

In addition to tube breakage events 318, imbalanced rotors due possibly to worn bearings or other wear and tear may cause vibrations or other abnormal operations.

FIG. 9 shows a block diagram of a second metric algorithm, namely a magnitude metric algorithm, that may be executed as metric algorithm 314 (cf. FIG. 3). During operation, a sound wave 316 may be produced by an abnormal operation of the centrifuge 100 causing, e.g., an elevated sound level. The abnormality may be different from a tube breakage event in that it does not cause a momentary spike but a longer lasting elevated sound level. Similar as described before with reference to FIG. 3, the sound wave 316 emanating from the centrifuge 100 may, e.g., be captured by microphone 302 and then be provided as the acoustic signal AS in, e.g., digital form.

After converting the analog acoustic signal to a digital waveform, one further embodiment of pre-processing 204B may be performed to assist in detecting abnormalities causing an elevated sound level of the centrifuge 100. The pre-processing 204B shown in FIG. 9 may be an embodiment of the pre-processing step 204 shown in FIG. 2.

The pre-processing 204B shown in FIG. 9 may be applied to detect abnormalities such as an unbalanced centrifuge rotor, or a failing bearing. A persistently elevated level may indicate abnormal operation. While the pop metric M_{P} described above is designed specifically to detect the sharp, brief “pop” a tube makes when breaking, it may not be as suitable to detect persistently elevated sound levels. However, abnormal centrifuge operation not associated with a tube breaking may typically give a persistently loud sound, rather than an abrupt, transient pop.

A main feature of the magnitude metric algorithm shown in FIG. 9 may be to detect a persistent increase in the acoustic signal magnitude, above a normal level. The magnitude metric algorithm may show a reduced sensitivity (or it may even be insensitive) to transient noises. Transient noises may include tubes breaking, but also various internal and external noises, such as a centrifuge lid or a room door closing, or other laboratory noises.

In an embodiment, a highpass filter 904 may be applied to the acoustic signal AS to provide a highpass filtered acoustic signal HFS. Opening and closing doors, though audible, often produce large subsonic components. Since these subsonic components may be large, and unrelated to abnormal centrifuge operation, it is advantageous to delete them. The highpass filter 904 is a simple, effective way to delete such subsonic components.

A noise-shaping filter 902 may be applied to the highpass filtered acoustic signal HFS, thereby generating a noise-shaped signal NSS. The noise shaped signal NSS generated by this module of the pre-processing 204B shown in FIG. 9 may be similar to or different from the noise shaped signal NSS generated by the first module of the pre-processing 204A shown in FIG. 4.

The acoustic signal AS and/or the noise shaped signal NSS also may contain high frequency components, both under normal and abnormal operation, which may cause rapid fluctuations in the acoustic signal AS and/or the noise shaped signal NSS within a time period of less than a millisecond. Thus, it may be helpful for pre-processing 204B to include a signal magnitude processing 906 which may include 1) magnitude calculation 920, which calculates a signal indicative of the magnitude of the acoustic signal AS (e.g., an acoustic signal magnitude ASM, a power such as acoustic signal squared, the absolute value of the acoustic signal, or other measure of the magnitude of the acoustic signal), then 2) a magnitude profile calculation 924 which may create a signal magnitude profile SMP by smoothing the acoustic signal magnitude ASM.

While the signal magnitude processing 906 applied in the magnitude metric algorithm shown in FIG. 9 may look similar to the signal magnitude processing 406 applied in the pop metric algorithm shown in FIG. 4, the resulting signal magnitude profiles SMP may differ. For example, a different smoothing may be applied during the magnitude profile calculation 924 than in the magnitude profile calculation 424.

The acoustic signal magnitude ASM may be obtained first at a predetermined acoustic sampling rate, e.g., at an acoustic sampling rate of about 32 kHz. Then it may be decimated during the magnitude profile calculation to produce the signal magnitude profile SMP at a lower sampling rate, e.g., as a 64-fold decimation, resulting in 500 Hz in the example, which may be used for subsequent analysis.

In a further module of the pre-processing 204B, magnitude profile ranges MPR are obtained in step 910, e.g., based on the signal magnitude profile SMP. During the obtaining magnitude profile ranges step 910, consecutive and/or overlapping sections of the signal magnitude profile SMP are output corresponding with appropriate time ranges. In step 910, the time ranges may be chosen with a predetermined duration (i.e., width) and at a predetermined repetition rate. For example, the time ranges may be chosen at a duration of about 0.5 s and a repetition rate of 0.1 s. Then, for these time ranges of 0.5 s duration, the time ranges 0 s-0.5 s, 0.1 s-0.6 s, 0.2 s-0.7 s, etc. may be chosen according to the repetition rate of 0.1 s. In other embodiments, different time ranges may be chosen, e.g., time ranges at a duration from about 0.1 s to about 3 s, more particular from about 0.2 s to about 2 s. Furthermore, slightly different repetition rates may be chosen, e.g., from 0.01 s to 1 s. These parameters and chosen time ranges may depend on the available computational resources and/or on aspects of the system which affect characteristics of the acoustic signal AS. Accordingly, slightly different consecutive and/or overlapping sections of the signal magnitude profile SMP are output as the magnitude profile ranges MPR, namely the signal magnitude profile SMP over the chosen time ranges.

Based on these obtained magnitude profile ranges MPR, a typical value is calculated in step 908, e.g., one typical value for each obtained magnitude profile range MPR. The typical value may be any means to estimate a typical or representative value of a set of numbers, e.g., the signal magnitude profile SMP within the corresponding magnitude profile range MPR. For example, the average may be used. The median may be more robust against outliers than the average, and the median-of-medians may be chosen as a close approximation of the median but requiring less computation. The typical value is also referred to as representative magnitude value RMV (cf. FIG. 12C).

When choosing the magnitude profile ranges MPR, e.g., every 0.1 s, a typical value and/or representative magnitude value RMV is output at this relatively low repetition rate, e.g., every 0.1 s.

The median of a time range like the representative magnitude value RMV does not need to be computed for every sampling position in the signal magnitude profile SMP. Rather, it may obtained frequently compared with the width of the data range, but infrequently compared with the sampling rate of the magnitude profile. For instance, if the signal magnitude profile SMP is 500 Hz and the width of the data range is 0.5 s, the median may be computed at 10 Hz. In other words, the median would be computed for the ranges of 0-0.5 s, 0.1-0.6 s, 0.2-0.7 s, etc. Thus, the median of 500 values is computed every 0.1 second.

Instead of computing the median as the representative magnitude value RMV of the signal magnitude profile SMP within a time range, the median-of-medians algorithm may be used, which gives a close approximation to the median, but with far less computation. For example, suppose the median of 500 values is to be estimated. The 500 values are divided into groups of 100 values each, and the median is estimated for each of the 100-value groups. Finally, the 500-point median is estimated as the median of the five 100-point estimates. Similarly, the median of 100 points is estimated by dividing the data into five groups of 20 points each. The median of each 20-point group is estimated. The median of the 100 points is estimated as the median of the five 20-point estimates. In turn, the median of 20 points is estimated by dividing the data into five 4-point groups. The median of each set of 4 points is determined. Since 4 points is less than 5, the exact median is easily computed. Then the median of the 20 points is estimated as the median of the five 4-point medians. Estimating the 500-point median then involves 31 5-point medians and 125 4-point medians. Since the usual median algorithm requires computation proportional to the square of the number of points, the median-of-medians require 31×5×5+125×4×4=2,775 (arbitrary computation units), whereas the 500-point median requires 500×500=250,000 units, nearly 2 orders of magnitude more computation. Even though there are more advanced algorithms to compute the exact median and still save some computation, the median of medians may provide a good compromise between requiring computation and providing a meaningful approximating being sufficient for the purpose of providing a representative value which is robust against outliers.

The obtained representative magnitude values RMV calculated in step 908 are also referred to as quantitation metric M_{Q}. The calculation of the quantitation metric M_{Q} may be the final step of the pre-processing 906 of the acoustic signal AS as done during the quantitation metric shown in FIG. 9.

A quantitation threshold T_{Q} may be established for the quantitation metric M_{Q}. The quantitation threshold T_{Q} may be based on typical values of the quantitation metric M_{Q} during normal operation, and at abnormal operation, e.g., with an unbalanced rotor 106. Typical representative magnitude values RMV of the quantitation metric M_{Q} during normal operation may be calculated real-time, possibly based on a history of the quantitation metric M_{Q} for a particular instrument, or they could be pre-determined based on measurements coming from a study. Similar as for the breakage threshold T_{B} as shown in FIG. 4, the quantitation threshold T_{Q} may be instrument specific. They may be based on known sound levels and/or deviations from known sound levels for normal operations of centrifuge 100.

In step 918, the quantitation threshold T_{Q} may be compared to the quantitation metric M_{Q} for detecting an abnormal operation of the centrifuge (step 932). Optionally, there could be a lower and higher quantitation threshold T_{Q}. When a representative magnitude value RMV like the quantitation metric M_{Q} exceeds the higher threshold T_{Q}, the centrifuge 100 may be halted. When a representative magnitude value RMV like the quantitation metric M_{Q} exceeds the lower threshold T_{Q}, but not the upper threshold T_{Q}, a warning like an alarm signal may be generated and/or issued to a user.

For tube breakage detection, magnitude profile calculation 424 may involve decimating the data, then applying a moving-average filter, which further smooths the magnitude. For detecting abnormal centrifuge operation by means of the quantitation metric algorithm shown in FIG. 9, the moving-average filter may be unnecessary. It may suffice just to decimate the magnitude, which involves calculating the average of successive groups of samples, e.g., samples 1-64, then 65-128, then 129-192, etc., and then replacing the data by the averages. This is because for detecting abnormal operation as shown in FIG. 9, a rise rate determination 412 is unnecessary, since there is no need to detect abrupt increases in the signal magnitude profile SMP. So, more samples may be grouped together, e.g., during the obtaining of the magnitude profile ranges MPR in step 910, resulting in a lower sampling frequency of the signal magnitude profile SMP.

In some cases, it may be possible to change the order of operations shown in FIG. 9. The highpass and noise-shaping filters 904 and 902 may be applied in either order, with identical results. Furthermore, if the noise-shaping filter 902 attenuates high frequencies, and magnitude profile calculation 924 involves only decimating the data, it may be possible to apply the noise-shaping filter 902 first, then decimate the data, then apply the highpass filter 904, and finally do the magnitude calculation 920. This may lower the sampling rate for the highpass filter 904 and the magnitude calculation 920, thereby decreasing the computational requirement.

FIG. 10A shows a plot of acoustic signal AS consistent with at least one embodiment of this disclosure. Acoustic signal AS may be the data collected from a transducer, such as acoustic transducer 108. As shown in FIG. 10A, acoustic signal AS may include a disturbance 1006 not caused by a persistent elevated noise level, but by, e.g., a momentary noise. The quantitation metric algorithm shown in FIG. 9 is not intended to detect momentary disturbances like the disturbance 1006, but a persistent elevated noise level instead.

FIG. 10A shows the acoustic signal AS when the rotor is driven with an (intentional) imbalance of 6 g, at a time from 12.5 s to 14.5 around the disturbance 1006. The disturbance 1006 may cause a spike in the acoustic signal AS. The spike may cause a mean magnitude of the acoustic signal AS to briefly peak above 0.03, even though the nearby magnitude was much lower. There appears to be a strong subsonic reverberation at about 10 Hz, lasting for about a second. This subsonic reverberation is consistent with a resonance mode of the air in the laboratory being excited by the opening or closing of a door. Though inaudible, it causes large excursions of the acoustic signal, which in turn, inflate the magnitude. This occurs over enough time to cause a substantial spike in the 0.5-second moving average of the magnitude.

FIG. 10B shows a plot of the highpass filtered acoustic signal HFS obtained from the acoustic signal AS shown in FIG. 10A after application of the highpass filter 904. Applying the highpass filter 904 (e.g., consecutively) may result in a much more complete subsonic attenuation than applying another filter, e.g., consecutive lowpass filters, then doing subtraction. In this exemplary embodiment, a 1^{st}-order recursive highpass filter having a corner frequency of 55 Hz is applied consecutively 4 times. This specific filter is computationally efficient. The recursive coefficient for the associated lowpass filter is 1/128, which can be accomplished through a bit shift rather than needing a multiply or divide. The highpass data is then the original data, minus the lowpass data.

Though there is still an increase in the amplitude of the highpass filtered acoustic signal HFS around the disturbance 1006, it is much more subtle and shorter lived than the spike shown in FIG. 10A in the unfiltered acoustic signal AS. The highpass filter 904 may generally reduce the amplitude somewhat, but the difference is prominent at 13.5 s where the large spike is replaced by a barely noticeable spike.

Thus, the highpass filter 904 may help reducing the influence of momentary disturbances which may be independent from the operation of the centrifuge 100 and should not be detected by the quantitation metric algorithm shown in FIG. 9.

Another possible improvement for robustness is to modify the way the typical value and/or the quantitation metric M_{Q} is determined in step 908. Here, the average may not be a robust indicator of typical values because there is no limit to how much effect a single outlier, if large enough, can have on the average. Therefore, the median is an example of a robust indicator for step 908. If a relatively small fraction of the data are outliers, the effect on the median is limited, regardless of how severe the outliers are.

Various percussive sounds can cause small portions of the acoustic signal AS to behave as outliers.

For instance, FIG. 11A shows a plot of an embodiment of the acoustic signal AS with an imbalance of 6 g on a timescale between 215 and 216 seconds. This section includes two sharp noises, each lasting about 50 milliseconds, caused by at least one disturbance 1106.

FIG. 11B shows a plot of a 0.5 s moving mean 1110 and a 0.5 s moving median 1112 of the signal magnitude profile SMP of the acoustic signal AS shown in FIG. 11A. The disturbances 1106 have a large effect on the moving mean 1110, but much less on the moving median 1112. Thus, using the median instead of the mean may greatly improve the distinction between brief noises and persistent changes in the signal magnitude, exactly what is needed for rotor imbalance detection.

The two improvements described above, i.e., the highpass filter 904 and using the moving median in step 908 when calculating the quantitation metric M_{Q}, may enable a fairly robust detection of rotor imbalance and other abnormalities which cause persistently noisier centrifuge operation. However, the algorithm may require more computation than a typical microcontroller can deliver. For instance, if the acoustic signal AS is sampled at 44.1 KHz, the 0.5 s moving median involves computing the median of 22,050 values, and the median is recomputed 44,100 times per second.

Therefore, a further improvement may involve decimating of the signal magnitude data. Therein, decimating may relate to reducing the sampling rate. In the pop metric algorithm shown in FIG. 4 regarding tube breakage detection, the acoustic signal magnitude ASM may be decimated and smoothed, yielding the signal magnitude profile SMP at a reduced sampling rate. In an example, the acoustic signal magnitude ASM is grouped into 16 values each, and the average of each group of 16 is computed. The average may represent the 16 values at a 16-fold reduction in the sampling rate.

This may be followed by a 5-point moving average to further smooth the data, resulting in the signal magnitude profile SMP.

A similar process may be used for the quantitation metric algorithm shown in FIG. 9, except that the smoothing is not necessary if a moving median (like a 0.5 s moving median) is applied to the signal magnitude profile SMP.

If the signal magnitude profile were decimated 16-fold for the quantitation metric algorithm shown in FIG. 9 also, as is done for the tube-breakage detection system, the sampling rate would be reduced from 44.1 KHz to 2,756 Hz in this example. A 0.5 s median would involve 1,378 values. But this may not be good enough, because it may still be beyond a microcontroller to compute 2,756 medians per second, each involving 1,378 values. However, FIG. 11B shows that the moving median is a slowly varying quantity. Thus, it may not be necessary to compute it 2,756 times per second. The plot shown in FIG. 11B may be understood to suggest that computing the moving median every 0.1 s may be sufficient, resulting in a “median profile”, as done with the quantitation metric M_{Q}.

Another way of reducing the required computational resources is to increase the amount of decimation. If the signal magnitude were decimated 80-fold (corresponding with the amount of smoothing done in the tube-breakage processing), the sampling rate is 551 Hz (in the exemplary embodiment), and each median would involve 276 values. Combining this with sampling the median every 0.1 s may reduce the computation further.

Another improvement may also reduce the computational requirements. If a threshold is established as the quantitation threshold T_{Q} such that if a median exceeds the quantitation threshold T_{Q}, abnormal centrifuge operation is indicated. Then, instead of calculating the median, the number of values of the signal magnitude profile SMP which exceed the quantitation threshold T_{Q} may be counted. If the count exceeds half of the number of values, the median has exceeded the quantitation threshold T_{Q}. This may be done very efficiently by using a circular buffer containing the last 0.5 s of the signal magnitude profile SMP. As each new value is put into the buffer, if its value exceeds the quantitation threshold T_{Q}, the count is incremented. If the oldest value which is now removed from the buffer exceeds the quantitation threshold T_{Q}, the count is decremented. If the resulting count exceeds half the number of values in the buffer, abnormal centrifuge operation may be detected at step 932.

Another possibility for reducing the computational requirements is to use the “median of medians” algorithm as an approximation to the median. This algorithm calculates the median of adjacent groups of 5 values each. Then the median of groups of 5 medians each is calculated. This may be continued as many times as desired. For instance, if the magnitude profile is sampled at 551 Hz, the first medians will be produces at 110 Hz, and second medians at 22 Hz. The 0.5 s median would then be computed using 11 values of the 22 Hz medians and could be sampled at 11 Hz.

Another improvement may be to include the noise-shaping filter 902 before calculating the magnitude. This has already been partly done with the highpass filter 904. In experiments used for testing the quantitation metric algorithm shown in FIG. 9, centrifuge imbalance causes noise with a broad spectrum, but the lower frequencies have somewhat better power to distinguish between normal and abnormal operation.

In an embodiment for the quantitation metric algorithm, named quantitation embodiment hereinafter, the region of each acoustic signal AS between 60 and 180 seconds may be isolated, corresponding to the centrifuge 100 running full speed. The decimation factor may be set to 80, and various first-order recursive lowpass filters are tried. The medians of the signal magnitude profile SMP may be sampled at 10 Hz. The minimum and maximum median may be determined for each run. The runs may be separated into two groups, depending on their imbalance between, in the quantitation embodiment, 0 g and 14 g.

The quantitation metric M_{Q} for the quantitation embodiment for reliably distinguishing between normal and abnormal runs may be constructed as follows: The logs of the minimum and maximum median over the magnitude profile ranges MPR may be computed for each run. The standard deviation of the logs of the minimum median of the abnormal group represents the ability to detect imbalance. The minimum may be chosen so that if the minimum is above a threshold, abnormality will be reliably detected at any point in the full-speed portion of the run. The standard deviation measures how much this metric varies within the group; the smaller the variation, the more capable the quantitation metric M_{Q} is of distinguishing between abnormal and normal. The standard deviation of the logs of the maximum median of the normal group represents the ability to avoid falsely detecting abnormality. The maximum may be chosen because if a single median value exceeds a threshold, abnormality is detected.

The standard deviation measures how much this quantitation metric M_{Q} varies across the runs which have an acceptable amount of imbalance. The smaller the standard deviation, the more capable the quantitation metric M_{Q} is of avoiding false positives. Next, the average of the logs of the minimum median of the abnormal group, and the average of the logs of the maximum median of the normal group may be calculated, and the difference between the two averages may be computed. The difference between the averages indicates how different the two groups are; the larger the difference, the more capable the quantitation metric M_{Q} is of distinguishing between abnormal and normal. Finally, the ratio of the difference to the pooled standard deviations of the abnormal group and the normal group is calculated. The larger the ratio, the more capable the quantitation metric M_{Q} is of distinguishing between abnormal and normal.

In the quantitation embodiment, the ratio may be 3.54 without any lowpass filtering, but may be improved to 4.76 with a lowpass filter having a corner frequency of 110 Hz.

The lowpass filter may be an instance of the noise shaping filter 902 shown in FIG. 9. This filtering corresponds to a filter coefficient of 1/64, thereby replacing multiplies or divides by bit shifts. The minimum and maximum medians without and with lowpass filtering may be plotted and/or evaluated (cf. plot shown in FIG. 12D below showing the minimum and maximum medians in the embodiment with lowpass filtering). Because the lowpass filter decreases the signal magnitude, the two plots may be on different scales. However, the ratio between the lower and upper plot limits may be the same, so the slopes may be directly compared. The lowpass filter may cause a noticeably greater distinction between runs with an imbalance of 6 g vs. 8 g and above, especially with the minimum medians.

FIG. 12A shows a plot of an acoustic signal AS from an imbalanced rotor consistent with at least one embodiment of this disclosure. The shown acoustic signal AS was caused by a rotor 106 imbalanced with a load of 14 g and shows a heavy spike at around 7 seconds. Clipping is clearly evident, so the original signal must have been quite loud at that time. The recording reveals that the centrifuge 100 was gradually speeding up at that time, and the imbalance excited a resonance which produced a loud rattling noise. This noise is not a transient like other previously-discussed noises. Rather, it is persistent over a period of nearly a second.

FIG. 12B shows a plot of the signal magnitude profile SMP of the acoustic signal AS shown in FIG. 12A, calculated during the signal processing 906 by the magnitude profile calculation 924 (cf. FIG. 9). As shown in FIG. 12B, the noise around 7 s passes through the filtering into the signal magnitude profile SMP.

FIG. 12C shows a plot of the representative magnitude value RMV resulting from the signal magnitude profile SMP shown in FIG. 12C. The representative magnitude value RMV are calculated in step 908 as shown in FIG. 9 and represent typical values. Because all the values of the signal magnitude profile SMP are elevated around 7 s, the representative magnitude values RMV (here calculated as 0.5 moving medians) are likewise elevated. Because this resonance lasts a little under a second, a 0.5 s median may be chosen. The 0.5 s window may be wide enough to exclude extraneous noises but narrow enough to include the resonance. Therefore, choosing a window from about 0.1 s to about 3 s, preferably from about 0.2 s to about 1 s, more preferably of about 0.5 s, as the duration of the magnitude profile ranges MPR may deliver improved results. The noise may even have a periodic nature.

FIG. 12D shows a plot of a quantitation metric M_{Q} calculated based on different runs with an imbalance from 0 g to 14 g. The plot is based on two sets of runs, performed on different days. The first set was run at an imbalance from 0 g to 6 g and its data points are identified as stars. The second set was run at an imbalance from 6 g to 14 g and its data points are identified as hollow circles. The second set contains all the abnormal runs and a single 6 g imbalance run which is not considered “abnormal.

From the plot and/or the evaluation, a threshold for detecting abnormal imbalance may be computed. In the plot, the maximums of the representative magnitude value RMVₘₐₓ are shown as the upper line, increasing from about 0.0077 at the imbalance of 0 g to about 0.035 at the imbalance of 14 g. Furthermore, the minimums of the representative magnitude value RMVₘᵢₙ are shown as the lower line, increasing from about 0.0045 at the imbalance of 0 g to nearly 0.029 at the imbalance of 14 g.

In this embodiment, a run with an imbalance of up to 6 g may be considered an acceptable imbalance, while a run with a higher imbalance (8 g to 14 g) may be considered an unacceptable imbalance.

The representative magnitude values RMV may be calculated as moving median as described above. The maximum of the representative magnitude value RMVₘₐₓ of the highest acceptable run with an imbalance of 6 g is about 0.01, and the minimum of the representative magnitude value RMVₘᵢₙ of a run with an imbalance of 14 g is about 0.29. The geometric mean of these is about 0.017. This value is about 70% higher than the maximum of the representative magnitude value RMVₘₐₓ at the run with 6 g, but 14 g gives a minimum of the representative magnitude value RMVₘᵢₙ about 70% higher than the threshold.

The threshold used here may be intended to avoid false positives at or below 6 g imbalance, and to avoid false negatives at or above 14 g imbalance. Though 8 g, 10 g and 12 g are considered “abnormal” in the embodiment, it may not be possible to reliably distinguish between 6 g and 8 g imbalance. Based on the shown sound of the recordings for the system under study, a 14 g imbalance is definitely objectionable and must be detected. On the other hand, although it is desirable to detect 8 g, 10 g, and 12 g, failure to detect imbalance at these levels may not be as harmful as not detecting higher imbalances.

Because the acoustic gain may vary from system to system, it may be good to calibrate using a balanced (or empty) rotor 106. The maximum of the representative magnitude value RMVₘₐₓ is determined, then the quantitation threshold T_{Q} may be set at from about 1.5 to 4 times that maximum median, in particular from about 2 to 2.5 times that maximum median, e.g., at 2.2 times that maximum median. The applied multiplier may likely depend on the characteristics of the system, and how well normal and abnormal runs are distinguishable. Generally, a greater distinguishability may allow for a larger multiplier.

For the data of the quantitation embodiment shown the plot of FIG. 12D, a maximum of the representative magnitude value RMVₘₐₓ of 0.0077 may give the quantitation threshold T_{Q} of 0.0077×2.2=0.0170.

To avoid stopping the centrifuge 100 for borderline cases, it may be advantageous to employ two thresholds as the quantitation threshold T_{Q}, e.g., 2.2 and 3.3 times the maximum of the representative magnitude value RMVₘₐₓ of the balanced rotor. Exceeding the higher threshold may halt the centrifuge 100, but only exceeding the lower threshold may cause a warning like an alarm signal to be issued.

FIG. 13 shows a plot of an acoustic signal AS of an imbalanced rotor consistent with at least one embodiment of this disclosure. The plot shows 0.05 s of the acoustic signal when the rotor 106 is at full speed at about 5100 RPM and there is a 14 g imbalance. The acoustic signal AS has a strong periodic component. Since the rotor speed is constant, Fourier analysis may be used to gain insight. A Fourier analysis of the acoustic signal AS using 65,536 samples and a Kaiser window having a shape factor of 8 shows that the rotor imbalance generates audio components corresponding with the rotor speed and its harmonics.

FIG. 14A shows a plot of the low-frequency portion a Fourier spectrum 1502 of an acoustic signal AS of a balanced rotor consistent with at least one embodiment of this disclosure. There are no prominent peaks shown in this graph, so the balanced rotor 106 does not seem to cause prominent fluctuating sounds.

FIG. 14B shows a plot of a low-frequency Fourier spectrum 1504 of an acoustic signal AS of an imbalanced rotor 106 consistent with at least one embodiment of this disclosure. There occur strong peaks at 85, 170 and 330 Hz, and a weaker peak at 255 Hz. These are all multiples of 85 Hz, so the other peaks are harmonics of 85 Hz. This corresponds to the rotor speed of 5100 RPM with 5100 RPM/60 s=85 Hz. This shows that the rotor imbalance generates audio components corresponding with the rotor speed and its harmonics.

While the Fourier analysis may detect these strong peaks, the Fourier analysis is computationally rather expensive. Additionally, the Fourier analysis requires the rotor speed to be extremely close to constant during the time sampled. In many embodiments, this may not be the case. Furthermore, neither the pop metric algorithm nor the quantitation metric algorithm described above are ideal to detect such periodic fluctuations on the acoustic signal AS. These disadvantages may be reduced and/or overcome by the algorithm described below.

FIG. 15 shows a block diagram of a third metric algorithm, namely a harmonic metric algorithm, that may be executed as metric algorithm 314 (cf. FIG. 3). During operation, a sound wave 316 may be produced by an abnormal operation of the centrifuge 100 causing, e.g., a periodically fluctuating sound level. The abnormality may be different from a tube breakage event in that it does not only cause a momentary spike but a periodic fluctuation. Similar as described before with reference to FIG. 3, the sound wave 316 emanating from the centrifuge 100 may, e.g., be captured by microphone 302 and then be provided as the acoustic signal AS, e.g., in digital form.

After converting the analog acoustic signal to a digital waveform, another embodiment of pre-processing 204C may be performed to assist in detecting abnormalities causing periodic fluctuations in the sound level of the centrifuge 100. The pre-processing 204C shown in FIG. 15 may be an embodiment of the pre-processing step 204 shown in FIG. 2.

The pre-processing 204C shown in FIG. 15 may be applied to detect abnormalities such as a malfunction of a drive train of the centrifuge 100 (which may or may not include the motor), a malfunction of the motor, a bearing malfunction of the rotor, and/or a structural malfunction of the rotor, e.g., a crack, e.g., in an ultra-centrifuge.

Though Fourier analysis may provide a very specific and sensitive means to detect rotor imbalance, the Fourier analysis may be too complex to implement in some centrifuges 100 for realtime processing. However, concepts from the Fourier analysis can be utilized in a manner which requires significantly less processing. An aspect of this may be knowledge about the rotation speed.

Therefore, means may be provided for determining each sample of the acoustic signal AS which corresponds with the rotor 106 passing a certain rotational position, e.g., a zero-position aligned with a tube access hole. The rotor speed may be assumed to be essentially constant for at least the duration of a single revolution. This allows for determining which acoustic readings correspond with angular positions of the rotor 106 at different angles o relative to the rotor 106 passing the zero-position, e.g., at 0, 45, 90, 135, 180, 225, 270 and 315 degrees.

The pre-processing 204C shown in FIG. 15 comprises a signal sampling wherein the acoustic signal AS is sampled in a circular buffer 1306. E.g., by detecting a zero degree position (or zero-position) of the rotor 106 at step 1302, an acoustic signal for one rotation AS_{R} may be extracted from the acoustic signal AS.

The acoustic signal AS might or might not be stored in the circular buffer 1306. Preferably, the storage used contains the acoustic signal for one rotation AS_{R}. But after the data is copied or otherwise used, it is no longer needed, and can be overwritten. Thus, using the circular buffer 1306 is advantageous, but not necessary. However, the circular buffer 1306 makes a convenient way to store data for the last, e.g., 50, revolutions and enables storing the samples of the acoustic signal AS at the specified angular positions.

Different predetermined angular positions of the rotor 106 may be predefined in the centrifuge 100, e.g., in the memory unit 112 shown in FIG. 1. These predefined angular positions of the rotor 106 may correspond to selected rotor angles RA, at which the acoustic signal for one rotation AS_{R} is sampled in step 1304 to obtain angular samples AS of the acoustic signal at the selected rotor angles RA. These angular samples AS_{φ} of the acoustic signal at the selected rotor angles RA may be stored in the circular buffer 1306, e.g., for each rotation of the rotor.

Further steps of the harmonic analysis of the pre-processing 204C shown in FIG. 15 may include:
a calculation of a fundamental in step 1310 based on the angular samples AS_{φ} of the acoustic signal at the selected rotor angles RA stored in the circular buffer 1306 for obtaining a fundamental component FC and/or.
a calculation of a harmonic, e.g., the second harmonic in step 1312, based on the angular samples AS_{φ} of the acoustic signal at the selected rotor angles RA stored in the circular buffer 1306 for obtaining a harmonic magnitude HM, e.g., a second harmonic magnitude.

The fundamental component FC and/or the harmonic magnitude HM may be used as a measurement of a periodic noise possibly related to the rotation of the rotor 106. The fundamental component FC and/or the harmonic magnitude HM may be used as fundamental metric M_{F} and/or harmonic metric M_{H}, respectively.

The harmonic analysis of the pre-processing 204C shown in FIG. 15 may be designed to specifically detect components having frequencies corresponding with the rotor speed (as fundamental) and with double the rotor speed (as harmonic). In Fourier analysis, the acoustic signal AS is multiplied, point by point, with a sine wave and with a cosine wave having the desired frequency, and the products are added together.

If the cosine wave has the same frequency as the signal, and is in phase with it, the products add constructively. If the cosine wave is of a different frequency, the products add randomly. In case the signal and the cosine are synchronized and in phase, the product is always positive, and cumulative sum of the product will stack.

However, the cosine may have a different frequency than the signal, e.g., 1.5 times that of the signal. Then, the signal and cosine may sometimes be in phase, and sometimes out of phase. Then, the product of the signal and the cosine may show positive and negative product values. Because there are about as much positive as negative product values, the cumulative sum of the products does not keep growing, but just wanders around zero. In this case, the maximum cumulative sum is less than when the cosine's frequency matches that of the signal.

The above example uses a cosine in phase with the signal. If the signal were delayed by 180 degrees, the products would all be negative, and the cumulative sum of the products would become increasingly large and negative as the number of cycles increases. However, if the signal were 90 degrees out of phase, some of the products would be positive, and others would be negative. The cumulative sum would not grow with an increased number of cycles. To counteract this difficulty, the data may be multiplied by the sine also. The power (i.e., magnitude squared) of the component corresponding with the rotor speed may be obtained by adding the squares of the cosine analysis and the sine analysis. The magnitude may be the square root of the power. Combining the sine and cosine analysis makes the analysis insensitive to the phase. As the phase shifts, the power shifts between the cosine and the sine analysis, much as a rotating vector shifts it components between X and Y, but the magnitude (i.e., length) remains constant.

In an exemplary embodiment, the sampling rate may be 44.1 KHz. Then, the cosine and sine analyses require 88,200 multiplications and 88,200 additions per second. However, if the data is only sampled when the rotor angles RA are, e.g., 0° and/or 180 degrees, the cosine values are +1 and −1, respectively. Here, no multiplications are needed, but only 2 adds or subtracts per revolution. The sine analysis may be accomplished similarly, e.g., by sampling the signal at 90 and 270 degrees, where the sine is +1 and −1, respectively.

However, this calculation is subject to “aliasing”. This effect occurs when, between adjacent samples, there is not the expected fraction of cycles, but that fraction plus some integer. For instance, in case the signal is sampled at 170 Hz to detect an 85 Hz component, there is half a cycle of 85 Hz between samples. But if a component is at, e.g., 3×85 Hz=255 Hz, there will be 1.5 cycles between samples. Based solely on the samples, the two frequencies may be indistinguishable. The 255 Hz component aliases as 85 Hz. Indeed, components having frequencies which are odd multiples of the rotor speed may then be indistinguishable at the sampling points. Thus, this method of sampling may not just respond to the fundamental (in the example, 85 Hz), but to all the odd harmonics (in the example, 255 Hz, 425 Hz, etc.). However, it may still be suitable for the purpose of detecting a rotor imbalance causing a periodic noise.

Detecting the second harmonic (in the example, 170 Hz) may be done similarly, except the signal may be sampled at 0 and 90 degrees rather than at 0 and 180 degrees (for the cosine analysis), and at 45 and 135 degrees rather than at 90 and 270 degrees (for the sine analysis). The sampling angles may be selected to be half of what is used for analyzing the fundamental. This analysis will respond to the 2nd, 6th, 10th, etc. harmonics. Again, this is suitable for detecting rotor imbalance. However, there are two cycles per revolution, starting at 0 and 180 degrees. Thus, the 2nd harmonic analysis may also use 180 and 270 degrees for cosine, and 225 and 315 degrees for sine analysis.

The above shows how the energy of the fundamental and 2nd harmonic for a single rotor revolution may be estimated at a lower computational cost than when using a Fourier analysis. The estimate may be improved by, for each angle, using the average of the signal for some number of rotations. This averaging may attenuate the effects of components of the acoustic signal which are unrelated to the rotation speed. Also, the cosine/sine analysis may be computed at other rotor positions RA than those listed above exemplarily. For instance, as described above, the fundamental component may use data at 0, 90, 180 and 270 degrees. But the same analysis may be performed at those positions, offset by 45 degrees, or perhaps at 22.5, 45, and 67.5 degrees, or some other number of offsets. Since the data at 45, 135, 225 and 315 degrees is already being used for the 2nd harmonic analysis, very little additional processing needs to be done to utilize them for the fundamental. Thus, according to a computational efficient embodiment, the harmonic analysis can be computed as follows:

$${E}_{1} = \frac{1}{2} [ {( {y}_{0} - {y}_{180} )}^{2} + {( {y}_{45} - {y}_{225} )}^{2} + {( {y}_{90} - {y}_{270} )}^{2} + {( {y}_{135} - {y}_{315} )}^{2} ]$$

$${E}_{2} = \frac{1}{2} [ {( {y}_{0} - {y}_{90} )}^{2} + {( {y}_{45} - {y}_{135} )}^{2} + {( {y}_{180} - {y}_{270} )}^{2} + {( {y}_{225} - {y}_{315} )}^{2} ]$$

Therein, E₁ and E₂ are the energy estimates of the fundamental and 2^{nd} harmonic, and yₙ is the average of the acoustic data at n degrees of the rotational angle RA, e.g., the average of the angular samples AS. for the rotational angle RA. The factor of ½ may be used to obtain the average result of the analyses starting at 0 and 45 degrees for E₁ and 0 and 180 degrees for E₂.

E₁ is an embodiment of the fundamental component FC and/or fundamental metric M_{F} calculated during the pre-processing 204C shown in FIGS. 15, and E₂ is an embodiment of the harmonic component HM and/or harmonic metric M_{H} calculated during the pre-processing 204C shown in FIG. 15.

The estimates for E₁ and E₂ may be considered as each combining two independent angular samplings for cosine analysis, along with their 90 or 45 degree shifted angular samplings for sine analysis. For instance, E₁ uses the two angular samplings at (0, 180) degrees and (45, 225) degrees for cosine analysis, along with (90, 270) degrees and (135, 315) degrees for sine analysis. Similarly, E₂ uses the angular samplings at (0, 90) degrees and (180, 270) degrees for cosine analysis, and the angular samplings at (45, 135) and (225, 315) for sine analysis. Any number of independent angular samplings may be used.

In the above paragraphs, the fundamental harmonic is estimated as fundamental component FC by combining two angular samplings, one at 0 and 180 degrees, and the other 90 degrees out of phase with the first angular sampling. The angles of 0 and 180 degrees are chosen for computational efficiency. However, other angular sampling angles could also be used. For instance, the angles could be 30, 90, 150, 210, 270 and 330 degrees, which corresponds with coefficients of 0.5, 1, 0.5 −0.5 −1 and −0.5. Using these coefficients require only an add or subtract, and a single bit shift, so this set of angles is also computationally efficient. It is not necessary that the angles be evenly spaced. Also, this method works for any number of angles, including just a single angle. However, the two samplings are preferably 90 degrees out of phase with each other in order for the result of combining them to be insensitive to the phase of the fundamental harmonic.

Similarly, the second harmonic is estimated as harmonic magnitude HM by combining two angular samplings which are 45 degrees out of phase with each other. Any number of angles can be used, including just a single angle, and the angles do not have to be evenly spaced.

Furthermore, the above explanation uses the terms “cosine analysis” and “sine analysis”. This is because the coefficients are related to the cosine or the sine of the set of angles (fundamental) or two times the set of angles (harmonic). However, the method works for other sets of coefficients which are not related to the cosine or sine, though these other sets of coefficients may give less accurate estimates for E₁ and E₂.

In the following, the method is further explained in reference to the selected rotor angles RA used by the above equations for E₁ and E₂. However, the further explanation is given exemplarily only and applies, as explained, also to methods in which other rotor angles RA are selected.

FIG. 16 shows a plot of the acoustic signal magnitude ASM, of the fundamental component FC according to the fundamental metric M_{F}, and of the harmonic magnitude HM according to the harmonic metric HM calculated based on different runs with different imbalances from 0 g to 14 g. Because the data for the first runs with the imbalances from 0 g to 6 g was recorded on a different date than the data for the other runs with the imbalances from 6 g to 14 g, the plot shows a break between these two data sets.

Also in this embodiment, a run with an imbalance of up to 6 g may be considered as an acceptable imbalance, and a run with a higher imbalance (8 g to 14 g) may be considered an unacceptable imbalance.

The acoustic signal magnitude ASM shown in the plot increases with imbalance by about 11 dB from 0 g to 14 g, namely from about −17 dB to about −6 dB. The fundamental component FC increases by about 16 dB from 0 g to 14 g, namely from about −22 dB to about −6 dB, and even to-5 dB on a run with an imbalance of 12 g. Notably, the 2^{nd} harmonic measured by the harmonic magnitude HM increases by about 32 dB from 0 g to 14 g, namely from about −34 dB to about −2 dB.

The plot shows that the 2^{nd} harmonic is nearly undetectable at the imbalance of 0 g, but increases with each imbalance increment, showing that the 2^{nd} harmonic is a very sensitive indicator of the rotor imbalance. This stands to reason: the fundamental is expected to be present at a relatively low level, but the 2^{nd} harmonic is caused by nonlinearities in the system response. When the stimulus is mild (at a small imbalance), the response is linear. But as the stimulus increases, the system is pushed farther into the nonlinear region, resulting in an increase of the 2^{nd} harmonic. Notably, the impression when listening to the recordings may be that the sound is smooth at low imbalance and becomes “buzzier” at higher imbalance. The “buzziness” corresponds to distortion and the abnormal magnitude of harmonics.

Because the acoustic signal magnitude ASM increases less steeply than the fundamental component FC and the harmonic magnitude HM, defining a significant threshold for the acoustic signal magnitude ASM for detecting an abnormality may prove challenging, or even be impossible.

In some embodiments, during the detection of an imbalance in step 1318 shown in FIG. 15, the fundamental component FC (as the fundamental metric M_{F}) is compared to a fundamental threshold T_{F} which may be stored in the centrifuge 100. Based on the empiric data shown in the plot in FIG. 16, the fundamental threshold T_{F} may be set somewhere between the fundamental component FC at the runs with an imbalance of 6 g (as acceptable imbalance) and the run with the imbalance of 8 g (as unacceptable imbalance). For the system in that the exemplary data shown in FIG. 16 was gathered, the fundamental threshold T_{F} may, e.g., be set somewhere in the range from about −13 dB to about −12 dB. When the fundamental component FC exceeds the fundamental threshold T_{F}, an imbalance is detected at step 1332 (cf. FIG. 15).

In some embodiments, during the detection of an imbalance in step 1318 shown in FIG. 15, the harmonic magnitude HM (as the harmonic metric M_{H}) is compared to a harmonic threshold T_{H} which may be stored in the centrifuge 100. Based on the empiric data shown in the plot in FIG. 16, the harmonic threshold T_{H} may be set somewhere between the harmonic magnitude HM at the runs with an imbalance of 6 g (as acceptable imbalance) and the run with the imbalance of 8 g (as unacceptable imbalance). For the system in that the exemplary data shown in FIG. 16 was gathered, the harmonic threshold T_{H} may, e.g., be set somewhere in the range from about −16 dB to about −12 dB. When the harmonic magnitude HM exceeds the fundamental threshold T_{H}, an imbalance is detected at step 1332 (cf. FIG. 15).

As discussed above, the harmonic magnitude HM and/or the harmonic metric M_{H} may be a more sensitive indicator of an unacceptable imbalance than the fundamental component FC and/or the fundamental metric M_{F}. In some embodiments, both the harmonic metric M_{H} and the fundamental metric M_{F} may be compared to their respective thresholds T_{H} and T_{F}, while in other embodiments only one of the is checked in step 1318. In any way, both the harmonic magnitude HM and/or the harmonic metric M_{H} and the fundamental component FC and/or the fundamental metric M_{F} may prove to be a better indicator for an abnormality than the acoustic signal magnitude ASM.

As described above, it is advantageous to attenuate subsonic components prior to analysis. Strong subsonic content can be caused by laboratory doors being opened or closed. Also, to make the analysis insensitive to sudden loud noises (including a tube breaking), rather than computing the average of the signal at each rotor position for a number of rotations, the median may be used. Similarly to the description above, the medians may only be computed at intervals of, e.g., 0.1 seconds. This reduces the computational load.

The angular samples AS, of the acoustic signal AS may be stored in circular buffers 1306, one buffer for each rotor position, also referred to as rotor angle RA (e.g., 0, 45, 90, etc. degrees). The length of the circular buffers 1306 may correspond to the number of rotations to be incorporated in the median.

The circular buffers 1306 may be updated at each revolution (e.g., about 85 times per second). Then every 0.1 seconds, the medians of the circular buffers 1306 may be computed, and E₁ and/or E₂ (or similar values, e.g., based on other angular samples AS for the fundamental component FC and/or the harmonic magnitude HM) may be computed as described above.

Therein, determining the median may be a somewhat compute-intensive activity. However, the “median of medians” algorithm requires much less computation and provides a good estimate of the median. For example, in case the circular buffer 1306 contains 50 values for each selected rotor angle RA, then the circular buffer 1306 may be subdivided into 5 groups of 10 values each, the median of each subgroup is determined, then the median of the 5 medians is determined to calculate the fundamental component FC and/or the harmonic magnitude HM.

To obtain the median of a subgroup of 10 values, it may further be divided into 5 groups of 2 values each, the median of each 2-value subgroup may be found, then the median of the 5 medians may be found. Thus, the median may be directly found only for groups of 5 or fewer values, which requires very little computation. The median estimate of 50 values may, thus, involve finding the medians of 6 groups of 5 values each, and 25 groups of 2 values each.

In addition to this analysis being relatively simple, it does not require the rotational speed of the rotor 106 to be fixed. Because the samples corresponding with zero degrees are known, the data may be automatically synchronized with the rotation. If the rotation speed is changing, the analysis may then still be valid. Thus, the analysis may detect excessive imbalance before the rotor 106 has even reached its full speed. This may enable detecting cases of severe imbalance, so the centrifuge 100 does not have to experience the stresses at full speed before shutting down.

During the pre-processing of the acoustic signal AS in step 204 and/or during the detection of the abnormality in step 206 shown in FIG. 2, either a pop metric algorithm as exemplarily shown in FIG. 4, or a quantity metric algorithm as exemplarily shown in FIG. 9, or a harmonic metric algorithm as exemplarily shown in FIG. 15 may be used to check for different kinds of abnormalities. In other embodiments two or all three of the above metric algorithms may be check in parallel and/or consecutively.

The above description includes references to the accompanying drawings, which form a part of the description. The drawings show, by way of illustration, specific embodiments in which the invention can be practiced. These embodiments are also referred to herein as “examples” or “embodiments.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

Further features, aspects and embodiments are provided below in the following clauses:

Clause 1. A method for controlling a centrifuge, the method comprising:
receiving, at a computing device, an acoustic signal via a sound transducer located proximate to a rotor of the centrifuge;
detecting, by the computing device, an abnormality in the acoustic signal, the abnormality in the acoustic signal correlated to an abnormality in an operation of the centrifuge; and
transmitting, by the computing device, a termination signal to a drive component of the centrifuge.

Clause 2. The method of clause 1, wherein the abnormality in the acoustic signal comprises a fluctuation in the acoustic signal received by the sound transducer.

Clause 3. The method of clause 1, wherein the abnormality in the acoustic signal comprises a momentary spike in the acoustic signal received by the sound transducer.

Clause 4. The method of clause 1, wherein detecting the abnormality in the acoustic signal comprises detecting a periodic fluctuation in the acoustic signal received by the sound transducer.

Clause 5. The method of clause 1, wherein detecting the abnormality in the acoustic signal comprises correlating the abnormality in the acoustic signal to an imbalance in the rotor.

Clause 6. The method of clause 1, wherein detecting the abnormality in the acoustic signal comprises correlating the abnormality in the acoustic signal to a sound associated with a tube breakage event.

Clause 7. The method of clause 1, wherein the acoustic signal is a voltage and detecting the abnormality in the acoustic signal comprises detecting a momentary spike in the voltage.

Clause 8. The method of clause 1, wherein detecting the abnormality in the acoustic signal comprises detecting a frequency spike in the acoustic signal.

Clause 9. The method of clause 1, further comprising preprocessing the acoustic signal via at least one of a pre-amp and an analog-to-digital converter (ADC).

Clause 10. The method of clause 1, further comprising filtering noise from the acoustic signal via a noise shaping filter.

Clause 11. The method of clause 1, wherein the abnormality in the acoustic signal comprises a deviation in the acoustic signal from a baseline.

Clause 12. The method of clause 11, wherein the deviation is correlated to a tube breakage event.

Clause 13. The method of clause 11, wherein the deviation is correlated to an imbalance in the rotor or a worn bearing associated with at least one of the rotor and the drive component.

Clause 14. The method of clause 1, wherein detecting the abnormality in the acoustic signal comprises using a machine learning algorithm.

Clause 15. The method of clause 1, wherein detecting the abnormality in the acoustic signal is carried out by using at least a machine learning algorithm.

Clause 16. The method of clause 1, further comprising transforming the acoustic signal to a signal indicative of a magnitude of the acoustic signal.

Clause 17. The method of clause 16, further comprising transforming the signal indicative of the magnitude of the acoustic signal to a signal magnitude profile by smoothing the signal indicative of the magnitude of the acoustic signal.

Clause 18. The method of clause 17, further comprising determining a signal rise rate by comparing the signal indicative of the magnitude of the acoustic signal and/or the signal magnitude profile at a plurality of closely-spaced times.

Clause 19. The method of clause 18, further comprising:
calculating a metric using the signal indicative of the magnitude of the acoustic signal and/or the signal magnitude profile and further using the signal rise rate; and
correlating the metric with the abnormality of the operation of the centrifuge.

Clause 20. The method of clause 19, wherein a spike of the metric is correlated with a tube breakage event.

Clause 21. The method of clause 19, wherein a persistent elevated value of the metric is correlated with the abnormality of the operation of the centrifuge.

Clause 22. At least one computer-readable medium comprising instructions to perform any of the methods of clauses 1-21.

Clause 23. An apparatus comprising means for performing any of the methods of clauses 1-21.

Clause 24. A method for detecting a tube breakage in a centrifuge, the method comprising:
receiving, at a computing device, an acoustic signal via a sound transducer located proximate to a rotor of the centrifuge containing a tube;
-detecting, by the computing device, an abnormality in the acoustic signal, the abnormality in the acoustic signal correlated to the tube breakage; and
transmitting, by the computing device, a termination signal to a drive component of the centrifuge.

Clause 25. The method of clause 24, wherein the abnormality in the acoustic signal comprises a momentary spike in the acoustic signal received by the sound transducer.

Clause 26. The method of clause 24, wherein detecting the abnormality in the acoustic signal comprises correlating the abnormality in the acoustic signal to a sound associated with a tube breakage event.

Clause 27. The method of clause 24, wherein the acoustic signal is a voltage and detecting the abnormality in the acoustic signal comprises detecting a momentary spike in the voltage.

Clause 28. The method of clause 24, wherein detecting the abnormality in the acoustic signal comprises detecting a frequency spike in the acoustic signal.

Clause 29. The method of clause 24, further comprising preprocessing the acoustic signal via a pre-amp and an analog-to-digital converter (ADC).

Clause 30. The method of clause 24, further comprising filtering noise from the acoustic signal via a noise shaping filter.

Clause 31. The method of clause 24, wherein the abnormality in the acoustic signal comprises a deviation in the acoustic signal from a baseline.

Clause 32. The method of clause 31, wherein the deviation is correlated to the tube breakage.

Clause 33. The method of clause 24, wherein the deviation is correlated to an imbalance in the rotor or a worn bearing associated with at least one of the rotor and the drive component.

Clause 34. The method of clause 24, wherein detecting the abnormality in the acoustic signal comprises using a machine learning algorithm.

Clause 35. The method of clause 24, wherein detecting the abnormality in the acoustic signal is carried out by using at least a machine learning algorithm.

Clause 36. The method of clause 24, further comprising transforming the acoustic signal to a signal indicative of a magnitude of the acoustic signal.

Clause 37. The method of clause 36, further comprising transforming the signal indicative of the magnitude of the acoustic signal to a signal magnitude profile by smoothing the signal indicative of the magnitude of the acoustic signal.

Clause 38. The method of clause 37, further comprising determining a signal rise rate by comparing the signal indicative of the magnitude of the acoustic signal and/or the signal magnitude profile at a plurality of closely-spaced times.

Clause 39. The method of clause 38, further comprising:
calculating a metric using the signal indicative of the magnitude of the acoustic signal and/or the signal magnitude profile and further using the signal rise rate; and
correlating the metric with the abnormality of the operation of the centrifuge.

Clause 40. The method of clause 39, wherein a spike of the metric is correlated with a tube breakage event.

Clause 41. The method of clause 39, wherein a persistent elevated value of the metric is correlated with the abnormality of the operation of the centrifuge.

Clause 42. At least one computer-readable medium comprising instructions to perform any of the methods of clauses 24-41.

Clause 43. An apparatus comprising means for performing any of the methods of clauses 24-41.

Clause 44. A centrifuge comprising:
a drive component;
a rotor coupled to the drive component;
an acoustic transducer located proximate the rotor;
a processor electrically coupled to the acoustic sensor and the drive component; and
a memory storing instructions that, when executed by the processor, cause the processor to perform actions comprising:
   receiving an acoustic signal from the acoustic transducer,
   detecting an abnormality in the acoustic signal, the abnormality in the acoustic signal correlated to an abnormality in an operation of the centrifuge, and
   transmitting a termination signal to the drive component.

Clause 45. The centrifuge of clause 44, wherein the acoustic transducer comprises at least one microphone.

Clause 46. The centrifuge of clause 44, wherein the acoustic transducer comprises an array of microphones.

Clause 47. The centrifuge of clause 44, wherein the abnormality in the acoustic signal comprises a fluctuation in the acoustic signal received by the sound transducer.

Clause 48. The centrifuge of clause 44, wherein the abnormality in the acoustic signal comprises a momentary spike in the acoustic signal received by the sound transducer.

Clause 49. The centrifuge of clause 44, wherein detecting the abnormality in the acoustic signal comprises additional instructions for detecting a periodic fluctuation in the acoustic signal received by the sound transducer.

Clause 50. The centrifuge of clause 44, wherein detecting the abnormality in the acoustic signal comprises additional instructions for correlating the abnormality in the acoustic signal to an imbalance in the rotor.

Clause 51. The centrifuge of clause 44, wherein detecting the abnormality in the acoustic signal comprises additional instructions for correlating the abnormality in the acoustic signal to a sound associated with a tube breakage event.

Clause 52. The centrifuge of clause 44, wherein the acoustic signal is a voltage and detecting the abnormality in the acoustic signal comprises additional instructions for detecting a momentary spike in the voltage.

Clause 53. The centrifuge of clause 44, wherein detecting the abnormality in the acoustic signal comprises additional instructions for detecting a frequency spike in the acoustic signal.

Clause 54. The centrifuge of clause 44, wherein the actions further comprise preprocessing the acoustic signal via a pre-amp and an analog-to-digital converter (ADC).

Clause 55. The centrifuge of clause 44, wherein the actions further comprise filtering noise from the acoustic signal via a noise shaping filter.

Clause 56. The centrifuge of clause 44, wherein the abnormality in the acoustic signal comprises a deviation in the acoustic signal from a baseline.

Clause 57. The centrifuge of clause 56, wherein the deviation is correlated to a tube breakage.

Clause 58. The centrifuge of clause 56, wherein the deviation is correlated to an imbalance in the rotor or a worn bearing associated with the rotor.

Clause 59. The centrifuge of clause 44, wherein the actions further comprise transforming the acoustic signal to a signal indicative of a magnitude of the acoustic signal.

Clause 60. The centrifuge of clause 59, wherein the actions further comprise transforming the signal indicative of the magnitude of the acoustic signal to a signal magnitude profile by smoothing the signal indicative of the magnitude of the acoustic signal.

Clause 61. The centrifuge of clause 60, wherein the actions further comprise determining a signal rise rate by comparing the signal indicative of the magnitude of the acoustic signal and/or the signal magnitude profile at a plurality of closely-spaced times.

Clause 62. The centrifuge of clause 61, wherein the actins further comprise: calculating a metric using the signal indicative of the magnitude of the acoustic signal and/or the signal magnitude profile and further using the signal rise rate; and correlating the metric with the abnormality of the operation of the centrifuge.

Clause 63. The centrifuge of clause 62, wherein a spike of the metric is correlated with a tube breakage event.

Clause 64. The centrifuge of clause 62, wherein a persistent elevated value of the metric is correlated with the abnormality of the operation of the centrifuge.

Clause 65. A centrifuge comprising:
a drive component;
a rotor coupled to the drive component;
an acoustic transducer located proximate the rotor;
a processor electrically coupled to the acoustic sensor and the drive component; and
a memory storing instructions that, when executed by the processor, cause the processor to perform actions comprising:
   receiving an acoustic signal via a sound transducer located proximate to a rotor of the centrifuge containing a tube,
   detecting an abnormality in the acoustic signal, the abnormality in the acoustic signal correlated to a tube breakage, and
   transmitting a termination signal to a drive component of the centrifuge.

Clause 66. The centrifuge of clause 65, wherein the acoustic transducer comprises a microphone.

Clause 67. The centrifuge of clause 65, wherein the acoustic transducer comprises an array of microphones.

Clause 68. The centrifuge of clause 65, wherein the abnormality in the acoustic signal comprises a momentary spike in the acoustic signal received by the sound transducer.

Clause 69. The centrifuge of clause 65, wherein detecting the abnormality in the acoustic signal comprises additional instructions for correlating the abnormality in the acoustic signal to a sound associated with the tube breakage.

Clause 70. The centrifuge of clause 65, wherein the acoustic signal is a voltage and detecting the abnormality in the acoustic signal comprises additional instructions for detecting a momentary spike in the voltage.

Clause 71. The centrifuge of clause 65, wherein detecting the abnormality in the acoustic signal comprises additional instructions for detecting a frequency spike in the acoustic signal.

Clause 72. The centrifuge of clause 65, wherein the actions further comprise preprocessing the acoustic signal via a pre-amp and an analog-to-digital converter (ADC).

Clause 73. The centrifuge of clause 65, wherein the actions further comprise filtering noise from the acoustic signal via a noise shaping filter.

Clause 74. The centrifuge of clause 73, wherein the deviation is correlated to the tube breakage.

Clause 75. The centrifuge of clause 65, wherein the actions further comprise transforming the acoustic signal to a signal indicative of a magnitude of the acoustic signal.

Clause 76. The centrifuge of clause 75, wherein the actions further comprise transforming the signal indicative of the magnitude of the acoustic signal to a signal magnitude profile by smoothing the signal indicative of the magnitude of the acoustic signal.

Clause 77. The centrifuge of clause 76, wherein the actions further comprise determining a signal rise rate by comparing the signal indicative of the magnitude of the acoustic signal and/or the signal magnitude profile at a plurality of closely-spaced times.

Clause 78. The centrifuge of clause 77, wherein the actions further comprise: calculating a metric using the signal indicative of the magnitude of the acoustic signal and/or the signal magnitude profile and further using the signal rise rate; and correlating the metric with the abnormality of the operation of the centrifuge.

Clause 79. The centrifuge of clause 78, wherein a spike of the metric is correlated with a tube breakage event.

Clause 80. The centrifuge of clause 78, wherein a persistent elevated value of the metric is correlated with the abnormality of the operation of the centrifuge.

### LIST OF REFERENCE NUMERALS

100 centrifuge
102 computing device
104 drive component
106 rotor
108 sound transducer
110 processor
112 memory unit
114 software module
116 acoustic data
118 user interface
120 communication port
122 I/O device
124 tube
200 method for controlling a centrifuge
202 receive acoustic signal
204 pre-processing
204A pre-processing
204B pre-processing
204C pre-processing
206 detect abnormality
208 discontinue centrifuge operation
210 activate alarm
212 signal for halting the centrifuge
300 processing system
302 microphone
304 circuit
306 pre-amp
308 digital converter
310 digital processing unit
312 micro processing unit
314 metric algorithm
316 sound wave
318 broken tube/tube breakage event
402 noise-shaping filter
406 signal magnitude processing
408 calculate pop metric
410 delay
412 rise rate determination
418 breakage detection
420 magnitude calculation
424 magnitude profile calculation
432 tube breakage identified
506 abnormality
526 normal centrifuge operation
606 smoother curve
608 rise
610 decline
704 local maximum
706 maximum value
802 normal operation
806 tube breakage event
902 noise-shaping filer
904 highpass filter
906 signal magnitude processing
908 calculate typical value/quantitation metric
910 obtain magnitude profile ranges
918 abnormity detection
920 magnitude calculation
924 magnitude profile calculation
932 abnormal operation detected
1006 disturbance
1106 disturbance
1110 moving mean
1112 moving median
1302 rotor at zero degree detection
1304 acoustic signal sampling
1306 circular buffer
1310 fundamental estimation
1312 second harmonic estimation
1318 imbalance detection
1332 imbalance detected
1502 Fourier spectrum of balanced rotor
1504 Fourier spectrum of imbalanced rotor
AS acoustic signal
AS_{R} acoustic signal for one rotation
AS_{φ} angular sample of the acoustic signal
ASM acoustic signal magnitude
FC fundamental component
HFS highpass filtered acoustic signal
HM harmonic magnitude
MPR magnitude profile ranges
M_{P} pop metric
M_{Q} quantitation metric
M_{F} fundamental metric
M_{H} harmonic metric
NSS noise shaped signal
RA selected rotor angle
RMV representative magnitude value
RMVₘₐₓ maximum of the representative magnitude value
RMVₘᵢₙ minimum of the representative magnitude value
SMP signal magnitude profile
SRR signal rise rate
T_{B} breakage threshold
T_{F} fundamental threshold
T_{H} harmonic threshold
T_{Q} quantitation threshold

1. A method for controlling a centrifuge (100) comprising a rotor (106) and a drive component (104) for the rotor (106), the method comprising:
receiving, at a computing device (102), an acoustic signal (AS) via a sound transducer (108) located proximate to the rotor (106) of the centrifuge (100);
pre-processing, by the computing device (102), the acoustic signal (AS) by emphasizing at least one predetermined signal feature of the acoustic signal (AS), the signal feature indicating an abnormal operation of the centrifuge (100);
detecting, by the computing device (102), an abnormal operation of the centrifuge (100) by processing the emphasized signal feature; and
generating, by the computing device (102), an alarm signal and/or a termination signal (212) if an abnormal operation of the centrifuge (100) is detected.

2. The method of claim 1, wherein:
the predetermined signal feature indicates a tube breakage event in the centrifuge (100) and/or other abnormal operation of the centrifuge (100); and
the computing device (102) detects as the abnormal operation the tube breakage event in the centrifuge (100) and/or the abnormal operation of the centrifuge (100).

3. The method of claim 1 or 2, wherein the signal feature of the acoustic signal (AS) corresponds to a momentary spike and/or an increased sound level and/or a periodic fluctuation in the acoustic signal (AS) received by the sound transducer (108).

4. The method of claim 3, wherein during the detection of the abnormal operation, the computing device (102):
correlates the momentary spike of the acoustic signal (AS) to a tube breakage event; and/or
correlates the increased sound level of the acoustic signal (AS) to an abnormal operation of the centrifuge (100), in particular of the rotor (106) and/or drive component (104); and/or
correlates the periodic fluctuation of the acoustic signal (AS) to an abnormal operation of the centrifuge (100), in particular of the rotor (106) and/or the drive component (104).

5. The method of any of the preceding claims, wherein the computing device (102):
evaluates the acoustic signal (AS) and/or the at least one predetermined signal feature by means of at least one metric (M_{P}; M_{Q}; M_{F}, M_{H}) for detecting the abnormal operation of the centrifuge (100); and
correlates the at least one metric (M_{P}; M_{Q}; M_{F}, M_{H}) to at least one metric-specific threshold (T_{B}; T_{Q}; T_{F}; T_{H}) for detecting the abnormal operation of the centrifuge (100).

6. The method of any of the preceding claims, wherein the computing device (102) calculates an acoustic signal magnitude (ASM) from the acoustic signal (AS).

7. The method of claim 6, wherein the computing device (102) calculates a signal magnitude profile (SMP) from the acoustic signal magnitude (ASM) by decimating and/or smoothing the acoustic signal magnitude (ASM).

8. The method of claim 7, further comprising:
calculating a quantitation metric (M_{Q}) by calculating at least one representative magnitude value (RMV) from at least one range of the signal magnitude profile (SMP); and
correlating the quantitation metric (M_{Q}) to an abnormal operation of the rotor (106) and/or other drive component (104) by using a quantitation threshold (T_{Q}).

9. The method of claim 8, wherein the representative magnitude value (RMV) is calculated as a moving median (1112) or as a median-of-medians of the signal magnitude profile (SMP) over a predetermined time range.

10. The method of claim 9, wherein the predetermined time range of the signal magnitude profile (SMP) is from about 0.05 s to about 3 s, in particular from about 0.2 s to 1 s.

11. The method of claim 6 or 7, wherein the computing device (102) calculates a signal rise rate (SRR) by comparing the acoustic signal magnitude (ASM) and/or the signal magnitude profile (SMP) at a plurality of closely-spaced times.

12. The method of claim 11, wherein the plurality of closely-spaced times includes two times less than 50 ms apart.

13. The method of claim 11 or 12, further comprising:
calculating a pop metric (M_{P}) using the acoustic signal magnitude (ASM) and/or the signal magnitude profile (SMP) and further using the signal rise rate (SRR); and
correlating a momentary spike in the pop metric (M_{P}) to a tube breakage event in the centrifuge.

14. The method of any of claims 1 to 5, wherein the acoustic signal (AS) is sampled at a plurality of different predetermined angular positions of the rotor (106), thereby providing a plurality of angular samples (AS) of the acoustic signal (AS), namely at least one angular sample (AS) at each of the different predetermined angular positions.

15. The method of claim 14, wherein the angular samples (AS) of the acoustic signal (AS) at the different predetermined angular positions of the rotor (106) are correlated to each other.

16. The method of claim 14 or 15, wherein:
consecutive and/or overlapping time ranges are established, each time range spanning over a plurality of rotations of the rotor (106); and
at each of the different predetermined angular positions, a representative angular value of the angular samples (AS) of the acoustic signal (AS) at the different angular positions for each of the established time ranges is determined, thereby providing a plurality of representative angular values of the angular samples (AS_{φ}).

17. The method of claim 16, wherein the representative angular values are calculated as median or as median-of-medians of the angular samples (AS) of the acoustic signal (AS) of the respective time range at the corresponding angular positions.

18. The method of any of claims 14 to 17, wherein:
a fundamental component (FC) of the acoustic signal (AS) is calculated using at least one angular sample (AS) of the acoustic signal (AS) and/or at least one representative angular value at at least a first predetermined angular position of the rotor (106) and, additionally, at least one correlated angular sample (AS) of the acoustic signal (AS) and/or at least one correlated representative angular value at the first predetermined angular position plus 90°; and/or
a harmonic magnitude (HM) of the acoustic signal (AS) is calculated using at least one angular sample (AS_{φ}) of the acoustic signal (AS) and/or at least one representative angular value at a second predetermined angular position of the rotor (106) and, additionally, at least one correlated angular sample (AS_{φ}) of the acoustic signal (AS) and/or at least one correlated representative angular value at the second predetermined angular position plus 45°.

19. The method of claim 18, wherein:
the fundamental component (FC) is calculated using angular samples (AS) at the angular position of the rotor (106) of 0°, 45°, 180°, and 225° and, additionally, correlated angular samples (AS) at the angular position of the rotor (106) of 90°, 135°, 270°, and 315°; and/or
the harmonic magnitude (HM) is calculated using angular samples (AS) at the angular position of the rotor (106) of 0°, 90°, 180°, and 270° and, additionally, correlated angular samples (AS_{φ}) at the angular position of the rotor (106) of 45°, 135°, 225°, and 315°.

20. The method of claim 18 or 19, further comprising:
calculating a fundamental metric (M_{F}) using the fundamental component (FC) and/or calculating a harmonic metric (M_{H}) using the harmonic magnitude (HM);
correlating the fundamental metric (M_{F}) and/or the harmonic metric (M_{H}) to an imbalanced rotation of the rotor (106) by using a fundamental threshold (T_{F}) for the fundamental metric (M_{F}) and/or a harmonic threshold (T_{H}) for the harmonic metric (M_{H}).

21. The method of claim 4 or 5, wherein during the detection of the abnormal operation, the computing device (102):
correlates the momentary spike of the acoustic signal (AS) to a tube breakage event by the method of any of claims 6 and 7 and 11 to 13; and/or
correlates the increased sound level of the acoustic signal (AS) to an abnormal operation of the centrifuge (100), in particular of the rotor (106) and/or drive component (104) by the method of any of claims 6 to 10; and/or
correlates the periodic fluctuation of the acoustic signal (AS) to an abnormal operation of the centrifuge (100), in particular of the rotor (106) and/or the drive component (104) by the method of any of claims 14 to 20.

22. A centrifuge (100) comprising:
a drive component (104);
a rotor (106) coupled to the drive component (104);
a sound transducer (108) located proximate the rotor (106); and
a computing device (102) electrically coupled to the sound transducer (108) and the drive component (104);
wherein the computing device (102) is configured to execute the method according to any of the preceding claims for controlling the centrifuge (100).
